(19) United States
(12) Patent Application Publication
(10) Pub. No.: US 2025/0389190 A1
(43) Pub. Date: Dec. 25, 2025

(54) GAS TURBINE ENGINE

(71) Applicant: General Electric Company, Evendale, OH (US)

(72) Inventors: Daniel Alan Niergarth, Norwood, OH (US); Jeffrey Donald Clements, Mason, OH (US); Jeffrey S. Spruill, Hillsboro, OH (US); Erich Alois Krammer, West Chester, OH (US); Matthew Kenneth MacDonald, Austin, TX (US); Scott Alan Schimmels, Miamisburg, OH (US); Laura Cerully Dial, Clifton Park, NY (US)

(21) Appl. No.: 19/305,850

(22) Filed: Aug. 21, 2025

Related U.S. Application Data
(63) Continuation-in-part of application No. 18/481,515, filed on Oct. 5, 2023, now Pat. No. 12,410,753.
Application No. 18/481,515 is a continuation-in-part of application No. 17/978,629, filed on Nov. 1, 2022, now abandoned.
(60) Provisional application No. 63/797,234, filed on Apr. 30, 2025.

(51) Int. Cl. F01D 5/02; F01D 25/00; F01D 25/12

(52) U.S. Cl. CPC F01D 5/02; F01D 25/005; F01D 25/12; F05D 2220/323; F05D 2230/31; F05D 2240/24; F05D 2260/20; F05D 2300/17

(57) ABSTRACT

A gas turbine engine is provided. The gas turbine engine includes: a turbomachine having a compressor section, a combustion section, and a turbine section arranged in serial flow order, the compressor section having a high pressure compressor defining a high pressure compressor exit area (A_{HPCExit}) in square inches; and a component within the turbomachine, the component including a nickel-based superalloy. The gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}×EGT/(A_{HPCExit}²×1000).

### CROSS-REFERENCE TO RELATED APPLICATIONS

This application is a non-provisional application claiming the benefit of priority under 35 U.S.C. § 119(e) to U.S. Provisional Application No. 63/797,234, filed Apr. 30, 2025, which is hereby incorporated by reference in its entirety. This application is also a continuation-in-part of U.S. application Ser. No. 18/481,515, filed Oct. 5, 2023, which is a continuation-in-part of U.S. application Ser. No. 17/978,629, filed Nov. 1, 2022, now abandoned. The related applications are incorporated by reference in their entireties.

### FIELD

The present disclosure relates to a gas turbine engine.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended FIGs., in which:

FIG. 1 is a schematic cross-sectional view of a three-stream engine in accordance with an exemplary embodiment of the present disclosure.

FIG. 2 is a close-up, schematic view of the exemplary three-stream engine of FIG. 1 with a cooled cooling air system in accordance with an exemplary embodiment of the present disclosure.

FIG. 3 is a close-up view of an aft-most stage of high pressure compressor rotor blades within the exemplary three-stream engine of FIG. 1.

FIG. 4 is a close-up, schematic view of the exemplary three-stream engine of FIG. 1 showing the cooled cooling air system of FIG. 2.

FIG. 5 is a schematic view of a thermal transport bus of the present disclosure.

FIG. 6 is a table depicting numerical values showing the relationships between various parameters in accordance with various example embodiments of the present disclosure.

FIG. 7 is a graph depicting a range of corrected specific thrust values and redline exhaust gas temperature values of gas turbine engines in accordance with various example embodiments of the present disclosure.

FIG. 8 is a schematic view of a ducted turbofan engine in accordance with an exemplary aspect of the present disclosure.

FIG. 9 is a schematic, close-up view of a gas turbine engine having a cooled cooling air system in accordance with another exemplary aspect of the present disclosure.

FIG. 10 is a schematic, close-up view of a gas turbine engine having a cooled cooling air system in accordance with yet another exemplary aspect of the present disclosure.

FIG. 11 is a schematic, close-up view of a gas turbine engine having a cooled cooling air system in accordance with still another exemplary aspect of the present disclosure.

FIG. 12 is a schematic view of a turbofan engine in accordance with another exemplary aspect of the present disclosure.

FIG. 13 is a perspective view of a turbine disk of a type used in gas turbine engines.

FIG. 14 is a table listing a first series of nickel-based superalloy compositions identified by the present invention as potential compositions for use as a turbine disk alloy.

FIG. 15 is a table compiling various predicted properties for the nickel-based superalloy compositions of FIG. 14.

FIG. 16 is a graph plotting creep and hold time fatigue crack growth rate from the data of FIG. 15.

FIG. 17 is a table listing a second series of nickel-based superalloy compositions identified by the present invention as potential compositions for use as a turbine disk alloy.

FIG. 18 is a table compiling various predicted properties for the nickel-based superalloy compositions of FIG. 17.

FIG. 19 is a graph plotting creep and hold time fatigue crack growth rate from the data of FIG. 18.

FIG. 20 is a table listing a third series of nickel-based superalloy compositions identified by the present invention as potential compositions for use as a turbine disk alloy.

FIG. 21 is a table compiling various properties determined for the nickel-based superalloy compositions of FIG. 20.

FIG. 22 is a graph plotting rupture data versus HTFCGR data for the nickel-based superalloy compositions of FIG. 20.

FIG. 23 contains a table listing a series of nickel-based superalloy compositions evaluated as potential compositions for use as a turbine disk alloy.

FIG. 24 is a bar graph representing 0.2% creep at 1300° F. and 100 ksi (about 705° C. and about 690 MPa) for eight of the experimental alloys listed in FIG. 23.

FIG. 25 is a graph plotting 0.2% creep at 1300° F. and 100 ksi (about 705° C. and about 690 MPa) for the eight experimental alloys of FIG. 24, as well as nine additional experimental alloys that were investigated and three alloys of the prior art.

FIG. 26 is a graph plotting 0.2% creep at 1300° F. and 100 ksi (about 705° C. and about 690 MPa) for those experimental alloys of FIG. 25 that exhibited phase stability, as well as the three alloys of the prior art.

FIG. 27a shows a back-scattered electron SEM image of Alloy 1 according to Example 1.

FIG. 27b shows an enlarged back-scattered electron SEM image of Alloy 1 according to Example 1.

FIG. 28a shows a back-scattered electron SEM image of Alloy 2 according to Example 1.

FIG. 28b shows an enlarged back-scattered electron SEM image of Alloy 2 according to Example 1.

FIG. 29a shows a back-scattered electron SEM image of Alloy 4 according to Example 1.

FIG. 29b shows an enlarged back-scattered electron SEM image of Alloy 4 according to Example 1.

FIG. 30a shows a back-scattered electron SEM image of Alloy 6 according to Example 1.

FIG. 30b shows an enlarged back-scattered electron SEM image of Alloy 6 according to Example 1.

FIG. 31a shows the grain boundary phase fraction of some of the alloys of Example 1.

FIG. 31b shows the grain boundary phase lineal density of some of the alloys of Example 1.

FIG. 32a shows the tensile properties, in terms of 0.2% yield strength, of the alloys 1-6 of Example 1 compared to Haynes® Alloy 282 (“HA282”).

FIG. 32b shows the tensile properties, in terms of elongation, of the alloys 1-6 of Example 1 compared to Haynes® Alloy 282 (“HA282”).

FIG. 33 shows the creep rupture properties of Alloys 1, 2, 4, 5, and 6 of Example 1 plotted as the Larson-Miller parameter (LMP) as a function of stress compared to HA282.

FIG. 34a shows the hold time low cycle fatigue (“LCF”) at 1700° F. (i.e., about 927° C.) at a strain range of 0.35% of the Alloys 1-6 of Example 1 compared to HA282.

FIG. 34b shows the hold time low cycle fatigue (“LCF”) at 1700° F. (i.e., about 927° C.) at a strain range of 0.5% of the Alloys 3, 4, 5, and 6 of Example 1 compared to HA282.

FIG. 35 shows the fracture toughness (K_{1C}) of Alloys 1, 2, 3, 5, and 6 of Example 1 compared to HA282, as measured at 1700° F. (i.e., about 927° C.).

FIG. 36 shows results of a cyclic oxidation test comparing Alloy 6 of Example 1 to HA282 at 1800° F. (i.e., about 982° C.) with cycles of 50 minutes in the furnace at 1800° F. and 10 minutes out of the furnace.

FIG. 37a shows a back-scattered electron SEM image of Alloy A according to Example 2.

FIG. 37b shows a back-scattered electron SEM image of Alloy B according to Example 2.

FIG. 37c shows a back-scattered electron SEM image of Alloy C according to Example 2.

FIG. 37d shows a back-scattered electron SEM image of Alloy D according to Example 2.

FIG. 37e shows a back-scattered electron SEM image of Alloy E according to Example 2.

FIG. 37f shows a back-scattered electron SEM image of Alloy F according to Example 2.

FIG. 38a shows the grain boundary phase fraction of the alloys of Example 2.

FIG. 38b shows the grain boundary phase lineal density of the alloys of Example 2.

FIG. 39 is a cross-sectional view of an exemplary metal article formed of a superalloy illustrating a grain structure.

FIG. 40 is a phase diagram of the superalloy.

FIG. 41 is a schematic view of an apparatus for pressure heating a metal article to form the grain structure shown in FIG. 39.

FIG. 42 is a block diagram of an exemplary method of processing the metal article of FIG. 39.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The term “cooled cooling air system” is used herein to mean a system configured to provide a cooling airflow to one or more components exposed to a working gas flowpath of a turbomachine of a gas turbine engine at a location downstream of a combustor of the turbomachine and upstream of an exhaust nozzle of the turbomachine, the cooling airflow being in thermal communication with a heat exchanger for reducing a temperature of the cooling airflow at a location upstream of the one or more components.

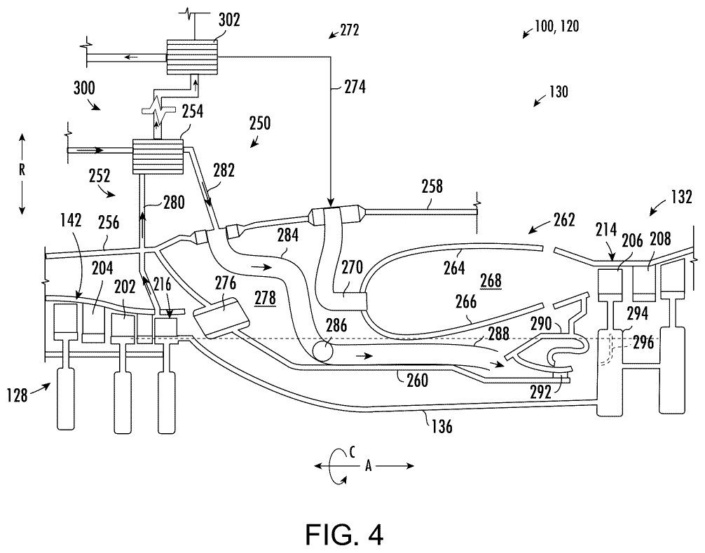

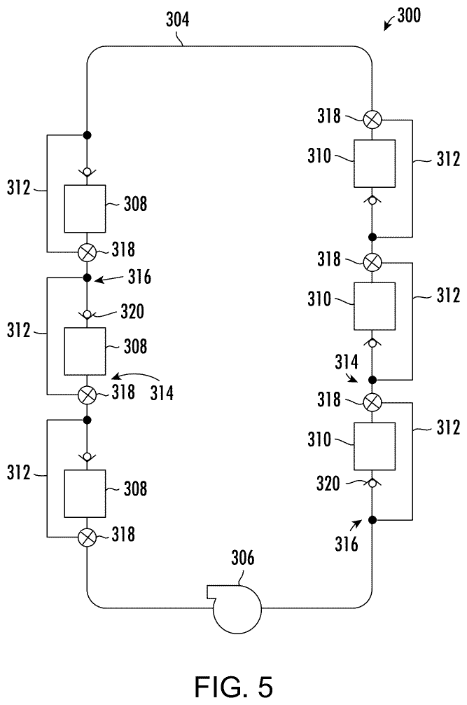

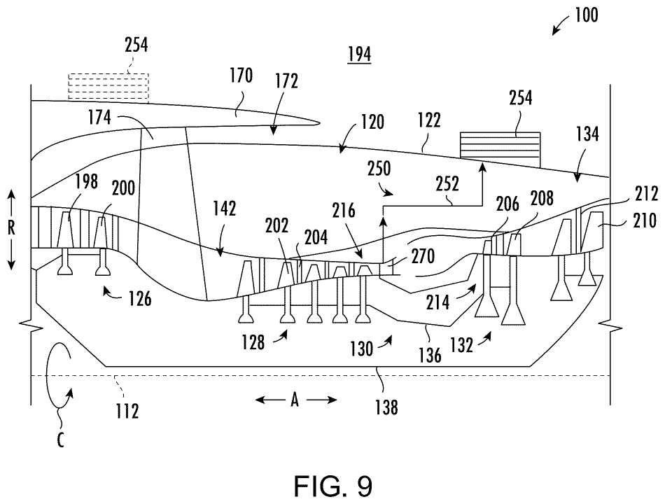

The cooled cooling air systems contemplated by the present disclosure may include a thermal bus cooled cooling air system (see, e.g., FIGS. 4 and 5) or a dedicated heat exchanger cooled cooling air system (i.e., a cooled cooling air system including a heat sink heat exchanger dedicated to the cooled cooling air system); a bypass heat exchanger cooled cooling air system having a heat sink heat exchanger thermally coupled to an airflow through a bypass passage (see, e.g., FIG. 9); an air-to-air cooled cooling air system (i.e., a cooled cooling air system having a heat sink heat exchanger configured to transfer heat to an airflow; see, e.g., FIG. 9); an oil-to-air cooled cooling air system (i.e., a cooled cooling air system having a heat sink heat exchanger configured to transfer heat to an oil flow); a fuel-to-air cooled cooling air system (i.e., a cooled cooling air system having a heat sink heat exchanger configured to transfer heat to a fuel flow, such as a Jet A fuel flow, a liquid hydrogen or hydrogen gas fuel flow, etc.; see, e.g., FIG. 4); or a combination thereof.

In one or more of the exemplary cooled cooling air systems described herein, the cooled cooling air system may receive the cooling air from a downstream end of a high pressure compressor (i.e., a location closer to a last stage of the high pressure compressor), an upstream end of the high pressure compressor (i.e., a location closer to a first stage of the high pressure compressor), a downstream end of a low pressure compressor (i.e., a location closer to a last stage of the low pressure compressor), an upstream end of the low pressure compressor (i.e., a location closer to a first stage of the low pressure compressor), a location between compressors, a bypass passage, a combination thereof, or any other suitable airflow source.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “takeoff power level” refers to a power level of a gas turbine engine used during a takeoff operating mode of the gas turbine engine during a standard day operating condition.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

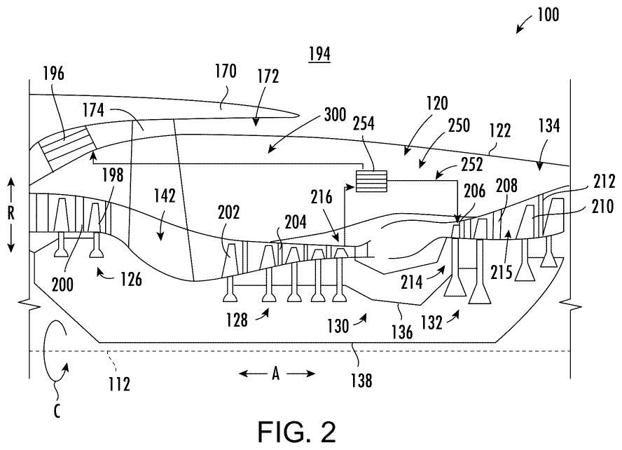

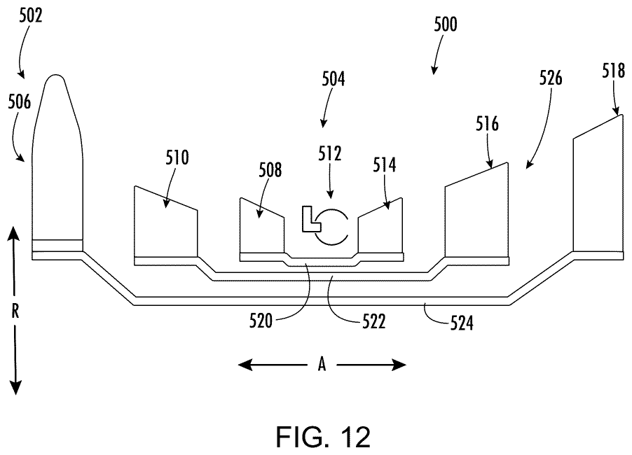

The term redline exhaust gas temperature (referred to herein as “redline EGT”) refers to a maximum permitted takeoff temperature documented in a Federal Aviation Administration (“FAA”)-type certificate data sheet. For example, in certain exemplary embodiments, the term redline EGT may refer to a maximum permitted takeoff temperature of an airflow after a first stage stator downstream of an HP turbine of an engine that the engine is rated to withstand. For example, with reference to the exemplary engine 100 discussed below with reference to FIG. 2, the term redline EGT refers to a maximum permitted takeoff temperature of an airflow after the first stator 208 downstream of the last stage of rotor blades 206 of the HP turbine 132 (at location 215 into the first of the plurality of LP turbine rotor blades 210). In embodiments wherein the engine is configured as a three spool engine (as compared to the two spool engine of FIG. 2; see FIG. 12), the term redline EGT refers to a maximum permitted takeoff temperature of an airflow after the first stator downstream of the last stage of rotor blades of the intermediate speed turbine (see intermediate speed turbine 516 of the engine 500 of FIG. 12). The term redline EGT is sometimes also referred to as an indicated turbine exhaust gas temperature or indicated turbine temperature.

In this context, a “metal” refers to a pure metal or a metal alloy (i.e., a compound of pure metals that may or may not include other non-oxygen elements). Examples of metals include aluminum, titanium, copper, and alloys thereof. A “superalloy” or “high-performance alloy” is a metal alloy that has improved properties compared to conventional alloys, such as improved strength, durability, temperature resistance, creep strength, and combinations thereof.

As used herein, the term “nickel or cobalt-containing base metal” refers to a base metal that comprises nickel, cobalt, nickel and cobalt alloys, as well as alloys of nickel, cobalt, or both with other metals such as iron, tungsten, molybdenum, chromium, manganese, titanium, aluminum, tantalum, niobium, zirconium, etc.

A “metal oxide” refers to a compound with a metallic element bonded to an oxygen atom, which includes ceramics such as aluminum oxide (alumina), silicon oxides, rust, among others. The term “metal” as used herein does not include metal oxides or salts that may contain metallic elements (such as sodium chloride, potassium chloride, or magnesium chloride).

A “solvus temperature” is a temperature at which a solid precipitate completely dissolves in a metal alloy.

A “low-reactive environment” is an environment in which oxidizing reactions with elements in a specific alloy are limited to below a specific threshold. The low-reactive environment may be an inert environment (e.g., filled with an inert gas such as argon, gettered to reduce or inhibit oxidation) or an environment with an oxygen concentration below a specific threshold (e.g., less than 1% oxygen).

It is to be understood that the use of “comprising” in conjunction with the alloy compositions described herein specifically discloses and includes the embodiments wherein the alloy compositions “consist essentially of” the named components (i.e., contain the named components and no other components that significantly adversely affect the basic and novel features disclosed), and embodiments wherein the alloy compositions “consist of” the named components (i.e., contain only the named components except for contaminants which are naturally and inevitably present in each of the named components).

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, “substantially” refers to at least 90% or more of the described group. For instance, as used herein, “substantially all” indicates that at least 90% or more of the respective group have the applicable trait and “substantially no” or “substantially none” indicates that at least 90% or more of the respective group do not have the applicable trait. As used herein, the “majority” refers to at least 50% or more of the described group. For instance, as used herein, “the majority of” indicates that at least 50% or more of the respective group have the applicable trait.

Generally, a turbofan engine includes a fan and a turbomachine, with the turbomachine rotating the fan to generate thrust. The turbomachine includes a compressor section, a combustion section, a turbine section, and an exhaust section and defines a working gas flowpath therethrough. A relatively small amount of thrust may also be generated by an airflow exiting the working gas flowpath of the turbomachine through the exhaust section. In addition, certain turbofan engines may further include a third stream that contributes to a total thrust output of the turbofan engine, potentially allowing for a reduction in size of a core of the turbomachine for a given total turbofan engine thrust output.

Conventional turbofan engine design practice has limited a compressor pressure ratio based at least in part on the gas temperatures at the exit stage of a high pressure compressor. These relatively high temperatures at the exit of the high pressure compressor may also be avoided when they result in prohibitively high temperatures at an inlet to the turbine section, as well as when they result in prohibitively high exhaust gas temperatures through the exhaust section. For a desired turbofan engine thrust output produced from an increased pressure ratio across the high pressure compressor, there is an increase in the gas temperature at the compressor exit, at a combustor inlet, at the turbine section inlet, and through an exhaust section of the turbofan engine.

The inventors have recognized that there are generally three approaches to making a gas turbine engine capable of operating at higher temperatures while providing a net benefit to engine performance: reducing the temperature of a gas used to cool core components, utilizing materials capable of withstanding higher operating temperature conditions, or a combination thereof.

Referring to the case of an engine that utilizes cooled cooling air for operating at higher temperatures, the inventors of the present disclosure discovered, unexpectedly, that the costs associated with achieving a higher compression by reducing gas temperatures used to cool core components to accommodate higher core gas temperatures may indeed produce a net benefit, contrary to prior expectations in the art. The inventors discovered during the course of designing several engine architectures of varying thrust classes and mission requirements (including the engines illustrated and described in detail herein) a relationship exists among the exhaust gas passing through the exhaust section, the desired maximum thrust for the engine, and the size of the exit stage of the high pressure compressor, whereby including this technology produces a net benefit. Previously it was thought that the cost for including a technology to reduce the temperature of gas intended for cooling compressor and turbine components was too prohibitive, as compared to the benefits of increasing the core temperatures.

For example, the inventors of the present disclosure found that a cooled cooling air system may be included while maintaining or even increasing the maximum turbofan engine thrust output, based on this discovery. The cooled cooling air system may receive an airflow from the compressor section, reduce a temperature of the airflow using a heat exchanger, and provide the cooled airflow to one or more components of the turbine section, such as a first stage of high pressure turbine rotor blades. In such a manner, a first stage of high pressure turbine rotor blades may be capable of withstanding increased temperatures by using the cooled cooling air, while providing a net benefit to the turbofan engine, i.e., while taking into consideration the costs associated with accommodations made for the system used to cool the cooling air.

The inventors reached this conclusion after evaluating potentially negative impacts to engine performance brought on by introduction of a cooled cooling air system. For example, a cooled cooling air system may generally include a duct extending through a diffusion cavity between a compressor exit and a combustor within the combustion section, such that increasing the cooling capacity may concomitantly increase a size of the duct and thus increase a drag or blockage of an airflow through the diffusion cavity, potentially creating problems related to, e.g., combustor aerodynamics. Similarly, a dedicated or shared heat exchanger of the cooled cooling air system may be positioned in a bypass passage of the turbofan engine, which may create an aerodynamic drag or may increase a size of the shared heat exchanger and increase aerodynamic drag. Size and weight increases associated with maintaining certain risk tolerances were also taken into consideration. For example, a cooled cooling air system must be accompanied with adequate safeguards in the event of a burst pipe condition, which safeguards result in further increases in the overall size, complexity, and weight of the system.

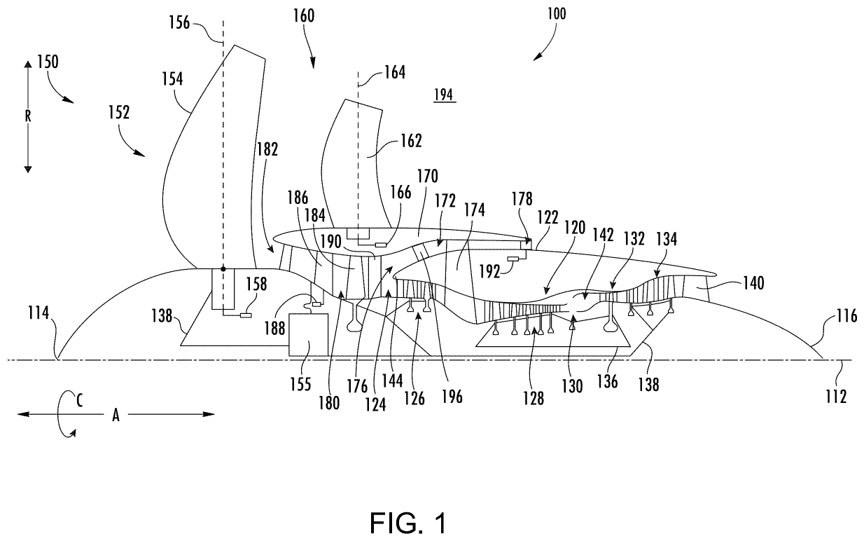

With a goal of arriving at an improved turbofan engine capable of operating at higher temperatures at the compressor exit and turbine inlet, the inventors have proceeded in the manner of designing turbofan engines having an overall pressure ratio, total thrust output, redline exhaust gas temperature, and the supporting technology characteristics; checking the propulsive efficiency and qualitative turbofan engine characteristics of the designed turbofan engine; redesigning the turbofan engine to have higher or lower compression ratios based on the impact on other aspects of the architecture, total thrust output, redline exhaust gas temperature, and supporting technology characteristics; rechecking the propulsive efficiency and qualitative turbofan engine characteristics of the redesigned turbofan engine; etc. during the design of several different types of turbofan engines, including the turbofan engines described below with reference to FIGS. 1 and 4 through 8 through 11, which will now be discussed in greater detail.

Referring now to FIG. 1, a schematic cross-sectional view of an engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 1 includes a third stream extending from a location downstream of a ducted mid-fan to a bypass passage over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section 130, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor of the combustion section 130 where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustion section 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustion section 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The working gas flowpath 142 is an annular duct positioned generally inward of the core cowl 122 along the radial direction R. The working gas flowpath 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween, and further defines a central blade axis 156. For this embodiment, each fan blade 154 of the fan 152 is rotatable about its respective central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170. Notably, the engine 100 defines a bypass passage 194 over the fan cowl 170 and core cowl 122.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan 152. The ducted fan 184 is, for the embodiment depicted, driven by the low pressure turbine 134 (e.g., coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan duct flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the working gas flowpath 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may cach be aerodynamically contoured to direct air flowing thereby. Other struts in addition to the stationary struts 174 may be used to connect and support the fan cowl 170 and/or core cowl 122. In many embodiments, the fan duct 172 and the working gas flowpath 142 may at least partially co-extend (generally axially) on opposite sides (e.g., opposite radial sides) of the core cowl 122. For example, the fan duct 172 and the working gas flowpath 142 may cach extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the working gas flowpath 142 and the fan duct 172 by the leading edge 144 of the core cowl 122. The inlet duct 180 is wider than the working gas flowpath 142 along the radial direction R. The inlet duct 180 is also wider than the fan duct 172 along the radial direction R. The secondary fan 184 is positioned at least partially in the inlet duct 180.

Notably, for the embodiment depicted, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vane 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vane 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb as well as cruise.

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 196 may be positioned in thermal communication with the fan duct 172. For example, one or more heat exchangers 196 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 196 may be an annular heat exchanger extending substantially 360 degrees in the fan duct 172 (e.g., at least 300 degrees, such as at least 330 degrees). In such a manner, the heat exchanger 196 may effectively utilize the air passing through the fan duct 172 to cool one or more systems of the engine 100 (e.g., a cooled cooling air system (described below), lubrication oil systems, compressor bleed air, electrical components, etc.). The heat exchanger 196 uses the air passing through duct 172 as a heat sink and correspondingly increases the temperature of the air downstream of the heat exchanger 196 and exiting the fan exhaust nozzle 178.

As will be appreciated, the engine 100 defines a total sea level static thrust output Fn_{Total}, corrected to standard day conditions, which is generally equal to a maximum total engine thrust. It will be appreciated that “sea level static thrust corrected to standard day conditions” refers to an amount of thrust an engine is capable of producing while at rest relative to the earth and the surrounding air during standard day operating conditions.

The total sea level static thrust output Fn_{Total} may generally be equal to a sum of: a fan stream thrust Fn_{Fan} (i.e., an amount of thrust generated by the fan 152 through the bypass passage 194), the third stream thrust Fn_{3S} (i.e., an amount of thrust generated through the fan duct 172), and a turbomachine thrust Fn_{TM} (i.e., an amount of thrust generated by an airflow through the turbomachine exhaust nozzle 140), each during the static, sea level, standard day conditions. The engine 100 may define a total sea level static thrust output Fn_{Total} greater than or equal to 15,000 pounds. For example, it will be appreciated that the engine 100 may be configured to generate at least 25,000 pounds and less than 80,000 pounds, such as between 25,000 and 50,000 pounds, such as between 35,000 and 45,000 pounds of thrust during a takeoff operating power, corrected to standard day sea level conditions.

As will be appreciated, the engine 100 defines a redline exhaust gas temperature (referred to herein as “EGT”), which is defined above, and for the embodiment of FIG. 1 refers to a maximum permitted takeoff temperature of an airflow after the first stator 208 downstream of the last stage of rotor blades 206 of the HP turbine 132 (at location 215 into the first of the plurality of LP turbine rotor blades 210; sec FIG. 2).

Referring now to FIG. 2, a close-up, simplified, schematic view of a portion of the engine 100 of FIG. 1 is provided. The engine 100, as noted above includes the turbomachine 120 having the LP compressor 126, the HP compressor 128, the combustion section 130, the HP turbine 132, and the LP turbine 134. The LP compressor 126 includes a plurality of stages of LP compressor rotor blades 198 and a plurality of stages of LP compressor stator vanes 200 alternatingly spaced with the plurality of stages of LP compressor rotor blades 198. Similarly, the HP compressor 128 includes a plurality of stages of HP compressor rotor blades 202 and a plurality of stages of HP compressor stator vanes 204 alternatingly spaced with the plurality of stages of HP compressor rotor blades 202. Moreover, within the turbine section, the HP turbine 132 includes at least one stage of HP turbine rotor blades 206 and at least one stage of HP turbine stator vanes 208, and the LP turbine 134 includes a plurality of stages of LP turbine rotor blades 210 and a plurality of stages of LP turbine stator vanes 212 alternatingly spaced with the plurality of stages of LP turbine rotor blades 210. With reference to the HP turbine 132, the HP turbine 132 includes at least a first stage 214 of HP turbine rotor blades 206.

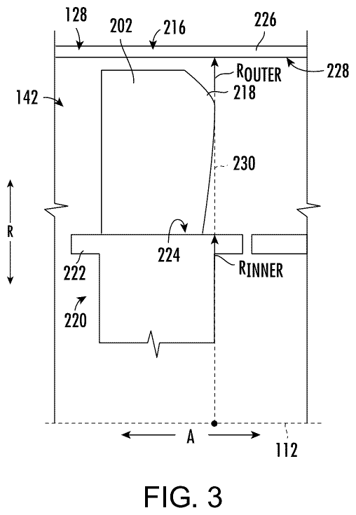

Referring particularly to the HP compressor 128, the plurality of stages of HP compressor rotor blades 202 includes an aftmost stage 216 of HP compressor rotor blades 202. Referring briefly to FIG. 3, a close-up view of an HP compressor rotor blade 202 in the aftmost stage 216 of HP compressor rotor blades 202 is provided. As will be appreciated, the HP compressor rotor blade 202 includes a trailing edge 218 and the aftmost stage 216 of HP compressor rotor blades 202 includes a rotor 220 having a base 222 to which the HP compressor rotor blade 202 is coupled. The base 222 includes a flowpath surface 224 defining in part the working gas flow path 142 through the HP compressor 128. Moreover, the HP compressor 128 includes a shroud or liner 226 located outward of the HP compressor rotor blade 202 along the radial direction R. The shroud or liner 226 also includes a flowpath surface 228 defining in part the working gas flow path 142 through the HP compressor 128.

The engine 100 (FIG. 3) defines a reference plane 230 intersecting with an aft-most point of the trailing edge 218 of the HP compressor rotor blade 202 depicted, the reference plane 230 being orthogonal to the axial direction A. Further, the HP compressor 128 defines a high pressure compressor exit area (A_{HPCExit}) within the reference plane 230. More specifically, the HP compressor 128 defines an inner radius (R_{INNER}) extending along the radial direction R within the reference plane 230 from the longitudinal axis 112 to the flowpath surface 224 of the base 222 of the rotor 220 of the aftmost stage 216 of HP compressor rotor blades 202, as well as an outer radius (R_{OUTER}) extending along the radial direction R within the reference plane 230 from the longitudinal axis 112 to the flowpath surface 228 of the shroud or liner 226. The HP compressor 128 exit area is defined according to Expression (1):

$${A}_{HPCExit} = π ( {R}_{OUTER}^{2} - {R}_{I NNER}^{2} ) . \qquad Expression ( 1 )$$

The inventors of the present disclosure have found that for a given total thrust output (Fn_{Total}), a decrease in size of the high pressure compressor exit area (A_{HPCExit}) may generally relate in an increase in a compressor exit temperature (i.e., a temperature of the airflow through the working gas flowpath 142 at the reference plane 230), a turbine inlet temperature (i.e., a temperature of the airflow through the working gas flowpath 142 provided to the first stage 214 of HP turbine rotor blades 206; see FIG. 2), and the redline exhaust gas temperature (EGT). In particular, the inventors of the present disclosure have found that the high pressure compressor exit area (A_{HPCExit}) may generally be used as an indicator of the above temperatures to be achieved by the engine 100 during operation for a given total thrust output (Fn_{Total}) of the engine 100.

Referring back to FIG. 2, the exemplary engine 100 depicted includes one or more technologies to accommodate the relatively small high pressure compressor exit area (A_{HPCExit}) for the total thrust output (Fn_{Total}) of the engine 100. In particular, for the embodiment depicted, the exemplary engine 100 includes a cooled cooling air system 250. The exemplary cooled cooling air system 250 is in fluid communication with the HP compressor 128 and the first stage 214 of HP turbine rotor blades 206. More specifically, for the embodiment depicted, the cooled cooling air system 250 includes a duct assembly 252 and a cooled cooling air (CCA) heat exchanger 254. The duct assembly 252 is in fluid communication with the HP compressor 128 for receiving an airflow from the HP compressor 128 and providing such airflow to the first stage 214 of HP turbine rotor blades 206 during operation of the engine 100. The CCA heat exchanger 254 is in thermal communication with the airflow through the duct assembly 252 for reducing a temperature of the airflow through the duct assembly 252 upstream of the first stage 214 of HP turbine rotor blades 206.

Briefly, as will be explained in more detail below, the engine 100 depicted further includes a thermal transport bus 300, with the CCA heat exchanger 254 of the cooled cooling air system 250 in thermal communication with, or integrated into, the thermal transport bus 300. For the embodiment depicted, the engine 100 further includes the heat exchanger 196 in the fan duct 172 in thermal communication with, or integrated into, the thermal transport bus 300, such that heat from the CCA heat exchanger 254 of the cooled cooling air system 250 may be transferred to the heat exchanger 196 in the fan duct 172 using the thermal transport bus 300.

Referring now to FIG. 4, a close-up, schematic view of the turbomachine 120 of the engine 100 of FIG. 2, including the cooled cooling air system 250, is provided.

As is shown, the turbine section includes a compressor casing 256, and the combustion section 130 of the turbomachine 120 generally includes an outer combustor casing 258, an inner combustor casing 260, and a combustor 262. The combustor 262 generally includes an outer combustion chamber liner 264 and an inner combustion chamber liner 266, together defining at least in part a combustion chamber 268. The combustor 262 further includes a fuel nozzle 270 configured to provide a mixture of fuel and air to the combustion chamber 268 to generate combustion gases.

The engine 100 further includes a fuel delivery system 272 including at least a fuel line 274 in fluid communication with the fuel nozzle 270 for providing fuel to the fuel nozzle 270.

The turbomachine 120 includes a diffuser nozzle 276 located downstream of the aftmost stage 216 of HP compressor rotor blades 202 of the HP compressor 128, within the working gas flowpath 142. In the embodiment depicted, the diffuser nozzle 276 is coupled to, or integrated with the inner combustor casing 260, the outer combustor casing 258, or both. The diffuser nozzle 276 is configured to receive compressed airflow from the HP compressor 128 and straighten such compressed air prior to such compressed air being provided to the combustion section 130. The combustion section 130 defines a diffusion cavity 278 downstream of the diffuser nozzle 276 and upstream of the combustion chamber 268.

As noted above, the exemplary engine 100 further includes the cooled cooling air system 250. The cooled cooling air system 250 includes the duct assembly 252 and the CCA heat exchanger 254. More specifically, the duct assembly 252 includes a first duct 280 in fluid communication with the HP compressor 128 and the CCA heat exchanger 254. The first duct 280 more specifically extends from the HP compressor 128, through the compressor casing 256, to the CCA heat exchanger 254. For the embodiment depicted, the first duct 280 is in fluid communication with the HP compressor 128 at a location in between the last two stages of HP compressor rotor blades 202. In such a manner, the first duct 280 is configured to receive a cooling airflow from the HP compressor 128 and to provide the cooling airflow to the CCA heat exchanger 254.

It will be appreciated, however, that in other embodiments, the first duct 280 may additionally or alternatively be in fluid communication with the HP compressor 128 at any other suitable location, such as at any other location closer to a downstream end of the HP compressor 128 than an upstream end of the HP compressor 128, or alternatively at a location closer to the upstream end of the HP compressor 128 than the downstream end of the HP compressor 128.

The duct assembly 252 further includes a second duct 282 extending from the CCA heat exchanger 254 to the outer combustor casing 258 and a third duct 284 extending from the outer combustor casing 258 inwardly generally along the radial direction R. The CCA heat exchanger 254 may be configured to receive the cooling airflow and to extract heat from the cooling airflow to reduce a temperature of the cooling airflow. The second duct 282 may be configured to receive cooling airflow from the CCA heat exchanger 254 and provide the cooling airflow to the third duct 284. The third duct 284 extends through the diffusion cavity generally along the radial direction R.

Moreover, for the embodiment depicted, the duct assembly 252 further includes a manifold 286 in fluid communication with the third duct 284 and a fourth duct 288. The manifold 286 extends generally along the circumferential direction C of the engine 100, and the fourth duct 288 is more specifically a plurality of fourth ducts 288 extending from the manifold 286 at various locations along the circumferential direction C forward generally along the axial direction A towards the turbine section. In such a manner, the duct assembly 252 of the cooled cooling air system 250 may be configured to provide cooling airflow to the turbine section at a variety of locations along the circumferential direction C.

Notably, referring still to FIG. 4, the combustion section 130 includes an inner stator assembly 290 located at a downstream end of the inner combustion chamber liner 266, and coupled to the inner combustor casing 260. The inner stator assembly 290 includes a nozzle 292. The fourth duct 288, or rather, the plurality of fourth ducts 288, are configured to provide the cooling airflow to the nozzle 292. The nozzle 292 may include a plurality of vanes spaced along the circumferential direction C configured to impart a circumferential swirl to the cooling airflow provided through the plurality of fourth ducts 288 to assist with such airflow being provided to the first stage 214 of HP turbine rotor blades 206.

In particular, for the embodiment depicted, the HP turbine 132 further includes a first stage HP turbine rotor 294, with the plurality of HP turbine rotor blades 206 of the first stage 214 coupled to the first stage HP turbine rotor 294. The first stage HP turbine rotor 294 defines an internal cavity 296 configured to receive the cooling airflow from the nozzle 292 and provide the cooling airflow to the plurality of HP turbine rotor blades 206 of the first stage 214. In such a manner, the cooled cooling air system 250 may provide cooling airflow to the HP turbine rotor blades 206 to reduce a temperature of the plurality HP turbine rotor blades 206 at the first stage 214 during operation of the engine 100.

For example, in certain exemplary aspects, the cooled cooling air system 250 may be configured to provide a temperature reduction of the cooling airflow equal to at least 15% of the EGT and up to 45% of the EGT. Further, in certain exemplary aspects, the cooled cooling air system 250 may be configured to receive between 2.5% and 35% of an airflow through the working gas flowpath 142 at an inlet to the HP compressor 128, such as between 3% and 20%, such as between 4% and 15%.

In addition, as briefly mentioned above, the cooled cooling air system 250 may utilize the thermal transport bus 300 to reject heat from the cooling air extracted from the compressor section of the turbomachine 120. In particular, for the embodiment shown the CCA heat exchanger 254 is in thermal communication with or integrated into the thermal transport bus 300. Notably, the thermal transport bus 300 further includes a fuel heat exchanger 302 in thermal communication with the fuel line 274. In such a manner, the thermal transport bus 300 may extract heat from the cooling air extracted from the compressor section through the cooled cooling air system 250 and provide such heat to a fuel flow through the fuel line 274 upstream of the fuel nozzle 270.

For the embodiment depicted, the thermal transport bus 300 includes a conduit having a flow of thermal transport fluid therethrough. More specifically, referring now briefly to FIG. 5, a schematic view of a thermal transport bus 300 as may be utilized with the exemplary engine 100 described above with reference to FIGS. 1 through 4 is provided.

The thermal transport bus 300 includes an intermediary heat exchange fluid flowing therethrough and is formed of one or more suitable fluid conduits 304. The heat exchange fluid may be an incompressible fluid having a high temperature operating range. Additionally, or alternatively, the heat exchange fluid may be a single phase fluid, or alternatively, may be a phase change fluid. In certain exemplary embodiments, the heat exchange fluid may be a supercritical fluid, such as a supercritical CO₂.

The exemplary thermal transport bus 300 includes a pump 306 in fluid communication with the heat exchange fluid in the thermal transport bus 300 for generating a flow of the heat exchange fluid in/through the thermal transport bus 300.

Moreover, the exemplary thermal transport bus 300 includes one or more heat source exchangers 308 in thermal communication with the heat exchange fluid in the thermal transport bus 300. Specifically, the thermal transport bus 300 depicted includes a plurality of heat source exchangers 308. The plurality of heat source exchangers 308 are configured to transfer heat from one or more of the accessory systems of an engine within which the thermal transport bus 300 is installed (e.g., engine 100 of FIGS. 1 through 4) to the heat exchange fluid in the thermal transport bus 300. For example, in certain exemplary embodiments, the plurality of heat source exchangers 308 may include one or more of: a CCA heat source exchanger (such as CCA heat exchanger 254 in FIGS. 2 and 4); a main lubrication system heat source exchanger for transferring heat from a main lubrication system; an advanced clearance control (ACC) system heat source exchanger for transferring heat from an ACC system; a generator lubrication system heat source exchanger for transferring heat from the generator lubrication system; an environmental control system (ECS) heat exchanger for transferring heat from an ECS; an electronics cooling system heat exchanger for transferring heat from the electronics cooling system; a vapor compression system heat source exchanger; an air cycle system heat source exchanger; and an auxiliary system(s) heat source exchanger.

For the embodiment depicted, there are three heat source exchangers 308. The heat source exchangers 308 are each arranged in series flow along the thermal transport bus 300. However, in other exemplary embodiments, any other suitable number of heat source exchangers 308 may be included and one or more of the heat source exchangers 308 may be arranged in parallel flow along the thermal transport bus 300 (in addition to, or in the alternative to the serial flow arrangement depicted). For example, in other embodiments there may be a single heat source exchanger 308 in thermal communication with the heat exchange fluid in the thermal transport bus 300, or alternatively, there may be at least two heat source exchangers 308, at least four heat source exchangers 308, at least five heat source exchangers 308, or at least six heat source exchangers 308, and up to twenty heat source exchangers 308 in thermal communication with heat exchange fluid in the thermal transport bus 300.

Additionally, the exemplary thermal transport bus 300 of FIG. 5 further includes one or more heat sink exchangers 310 permanently or selectively in thermal communication with the heat exchange fluid in the thermal transport bus 300. The one or more heat sink exchangers 310 are located downstream of the plurality of heat source exchangers 308 and are configured for transferring heat from the heat exchange fluid in the thermal transport bus 300, e.g., to atmosphere, to fuel, to a fan stream, etc. For example, in certain embodiments the one or more heat sink exchangers 310 may include at least one of a RAM heat sink exchanger, a fuel heat sink exchanger, a fan stream heat sink exchanger, a bleed air heat sink exchanger, an engine intercooler heat sink exchanger, a bypass passage heat sink exchanger, or a cold air output heat sink exchanger of an air cycle system. The fuel heat sink exchanger is a “fluid to heat exchange fluid” heat exchanger wherein heat from the heat exchange fluid is transferred to a stream of liquid fuel (see, e.g., fuel heat exchanger 302 of the engine 100 of FIG. 4). Moreover, the fan stream heat sink exchanger is generally an “air to heat exchange fluid” heat exchanger which transfers heat from the heat exchange fluid to an airflow through the fan stream (see, e.g., heat exchanger 196 of FIGS. 1 and 2). Further, the bleed air heat sink exchanger is generally an “air to heat exchange fluid” heat exchanger which flows, e.g., bleed air from the LP compressor 126 over the heat exchange fluid to remove heat from the heat exchange fluid.

For the embodiment of FIG. 5, the one or more heat sink exchangers 310 of the thermal transport bus 300 depicted includes a plurality of individual heat sink exchangers 310. More particularly, for the embodiment of FIG. 5, the one or more heat sink exchangers 310 include three heat sink exchangers 310 arranged in series. The three heat sink exchangers 310 are configured as a bypass passage heat sink exchanger, a fuel heat sink exchanger, and a fan stream heat sink exchanger. However, in other exemplary embodiments, the one or more heat sink exchangers 310 may include any other suitable number and/or type of heat sink exchangers 310. For example, in other exemplary embodiments, a single heat sink exchanger 310 may be provided, at least two heat sink exchangers 310 may be provided, at least four heat sink exchangers 310 may be provided, at least five heat sink exchangers 310 may be provided, or up to twenty heat sink exchangers 310 may be provided. Additionally, in still other exemplary embodiments, two or more of the one or more heat sink exchangers 310 may alternatively be arranged in parallel flow with one another.

Referring still to the exemplary embodiment depicted in FIG. 5, one or more of the plurality of heat sink exchangers 310 and one or more of the plurality of heat source exchangers 308 are selectively in thermal communication with the heat exchange fluid in the thermal transport bus 300. More particularly, the thermal transport bus 300 depicted includes a plurality of bypass lines 312 for selectively bypassing each heat source exchanger 308 and each heat sink exchanger 310 in the plurality of heat sink exchangers 310. Each bypass line 312 extends between an upstream juncture 314 and a downstream juncture 316—the upstream juncture 314 located just upstream of a respective heat source exchanger 308 or heat sink exchanger 310, and the downstream juncture 316 located just downstream of the respective heat source exchanger 308 or heat sink exchanger 310.

Additionally, each bypass line 312 meets at the respective upstream juncture 314 with the thermal transport bus 300 via a three-way valve 318. The three-way valves 318 each include an inlet fluidly connected with the thermal transport bus 300, a first outlet fluidly connected with the thermal transport bus 300, and a second outlet fluidly connected with the bypass line 312. The three-way valves 318 may each be a variable throughput three-way valve, such that the three-way valves 318 may vary a throughput from the inlet to the first and/or second outlets. For example, the three-way valves 318 may be configured for providing anywhere between zero percent (0%) and one hundred percent (100%) of the heat exchange fluid from the inlet to the first outlet, and similarly, the three-way valves 318 may be configured for providing anywhere between zero percent (0%) and one hundred percent (100%) of the heat exchange fluid from the inlet to the second outlet.

Notably, the three-way valves 318 may be in operable communication with a controller of an engine including the thermal transport bus 300 (e.g., engine 100 of FIGS. 1 through 4).

Further, each bypass line 312 also meets at the respective downstream juncture 316 with the thermal transport bus 300. Between each heat source exchanger 308 or heat sink exchanger 310 and downstream juncture 316, the thermal transport bus 300 includes a check valve 320 for ensuring a proper flow direction of the heat exchange fluid. More particularly, the check valve 320 prevents a flow of heat exchange fluid from the downstream juncture 316 towards the respective heat source exchanger 308 or heat sink exchanger 310.

As alluded to earlier, the inventors discovered, unexpectedly during the course of gas turbine engine design-i.c., designing gas turbine engines having a variety of different high pressure compressor exit areas, total thrust outputs, redline exhaust gas temperatures, and supporting technology characteristics and evaluating an overall engine performance and other qualitative turbofan engine characteristics—a significant relationship between a total sea level static thrust output, a compressor exit area, and a redline exhaust gas temperature that enables increased engine core operating temperatures and overall engine propulsive efficiency. The relationship can be thought of as an indicator of the ability of a turbofan engine to have a reduced weight or volume as represented by a high pressure compressor exit area, while maintaining or even improving upon an overall thrust output, and without overly detrimentally affecting overall engine performance and other qualitative turbofan engine characteristics. The relationship applies to an engine that incorporates a cooled cooling air system, builds portions of the core using material capable of operating at higher temperatures, or a combination of the two. Significantly, the relationship ties the core size (as represented by the exit area of the higher pressure compressor) to the desired thrust and exhaust gas temperature associated with the desired propulsive efficiency and practical limitations of the engine design, as described below.

Referring to the case of an engine that utilizes cooled cooling air for operating at higher temperatures, the inventors discovered, unexpectedly, that the costs associated with achieving a higher compression, enabled by reducing gas temperatures used to cool core components to accommodate higher core gas temperatures, may indeed produce a net benefit, contrary to expectations in the art. Referring to the case of utilizing more temperature-resistant material, such as a Carbon Matrix Composite (CMC), it was found that certain aspects of the engine size, weight and operating characteristics can be positively affected while taking into account the complexities and/or drawbacks associated with such material. In either case, the relationship now described can apply to identify the interrelated operating conditions and core size-i.e., total sea level static thrust, redline exhaust gas temperature, and compressor exit area, respectively.

The inventors of the present disclosure discovered bounding the relationship between a product of total thrust output and redline exhaust gas temperature at a takeoff power level and the high pressure compressor exit area squared (corrected specific thrust) can result in a higher power density core. This bounded relationship, as described herein, takes into due account the amount of overall complexity and cost, and/or a low amount of reliability associated with implementing the technologies required to achieve the operating temperatures and exhaust gas temperature associated with the desired thrust levels. The amount of overall complexity and cost may be prohibitively high for gas turbine engines outside the bounds of the relationship as described herein, and/or the reliability may prohibitively low outside the bounds of the relationship as described herein. The relationship discovered, infra, can therefore identify an improved engine configuration suited for a particular mission requirement, one that takes into account efficiency, weight, cost, complexity, reliability, and other factors influencing the optimal choice for an engine configuration.

In addition to yielding an improved gas turbine engine, as explained in detail above, utilizing this relationship, the inventors found that the number of suitable or feasible gas turbine engine designs capable of meeting the above design requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationship providing for the improved gas turbine engine, discovered by the inventors, is expressed as:

$$CST = {Fn}_{Total} \times EGT / ( {A}_{HPCExit}^{2} \times 1000 ) , \qquad Expression ( 2 )$$

where CST is corrected specific thrust; Fn_{Total} is a total sea level static thrust output of the gas turbine engine in pounds; EGT is redline exhaust gas temperature in degrees Celsius; and A_{HPCExit} is a high pressure compressor exit area in square inches.

CST values of an engine defined by Expression (2) in accordance with various embodiments of the present disclosure are from 42 to 90, such as from 45 to 80, such as from 50 to 80. The units of the CST values may be pounds-degrees Celsius over square inches.

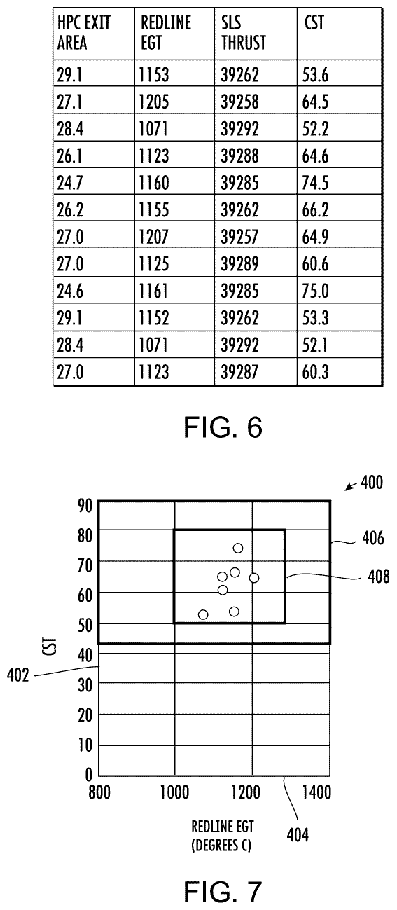

Referring now to FIGS. 6 and 7, various exemplary gas turbine engines are illustrated in accordance with one or more exemplary embodiments of the present disclosure. In particular, FIG. 6 provides a table including numerical values corresponding to several of the plotted gas turbine engines in FIG. 7. FIG. 7 is a plot 400 of gas turbine engines in accordance with one or more exemplary embodiments of the present disclosure, showing the CST on a Y-axis 402 and the EGT on an X-axis 404.

As shown, the plot 400 in FIG. 7 depicts a first range 406, with the CST values between 42 and 90 and EGT values from 800 degrees Celsius to 1400 degrees Celsius. FIG. 7 additionally depicts a second range 408, with the CST values between 50 and 80 and EGT values from 1000 degrees Celsius to 1300 degrees Celsius. It will be appreciated that in other embodiments, the EGT value may be greater than 1100 degree Celsius and less than 1250 degrees Celsius, such as greater than 1150 degree Celsius and less than 1250 degrees Celsius, such as greater than 1000 degree Celsius and less than 1300 degrees Celsius.

It will be appreciated that although the discussion above is generally related to an open rotor engine having a particular cooled cooling air system 250 (FIG. 2), in various embodiments of the present disclosure, the relationship outlined above with respect to Expression (2) may be applied to any other suitable engine architecture, including any other suitable technology(ies) to allow the gas turbine engine to accommodate higher temperatures to allow for a reduction in the high pressure compressor exit area, while maintaining or even increasing the maximum turbofan engine thrust output without, e.g., prematurely wearing various components within the turbomachine exposed the working gas flowpath.

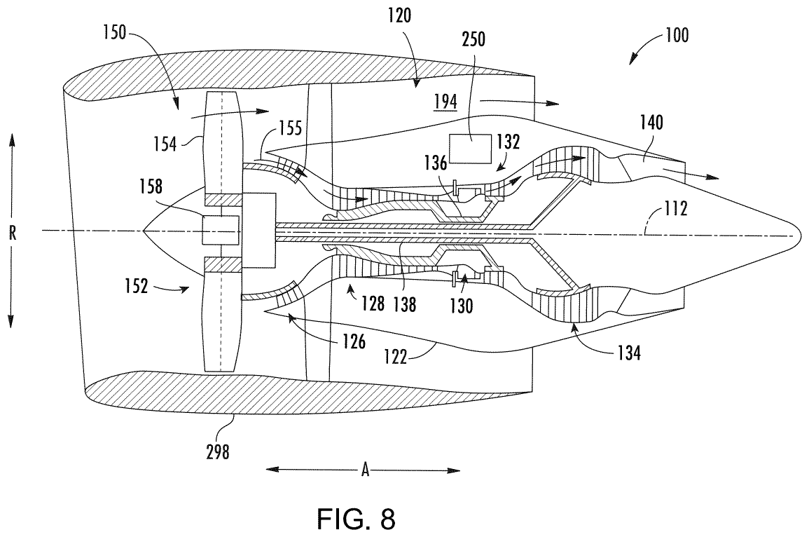

For example, reference will now be made to FIG. 8. FIG. 8 provides a schematic view of an engine 100 in accordance with another exemplary embodiment of the present disclosure. The exemplary embodiment of FIG. 8 may be configured in substantially the same manner as the exemplary engine 100 described above with respect to FIGS. 1 through 4, and the same or similar reference numerals may refer to the same or similar parts. However, as will be appreciated, for the embodiment shown, the engine 100 further includes an outer housing or nacelle 298 circumferentially surrounding at least in part a fan section 150 and a turbomachine 120. The nacelle 298 defines a bypass passage 194 between the nacelle 298 and the turbomachine 120.

Briefly, it will be appreciated that the exemplary engine 100 of FIG. 8 is configured as a two-stream engine, i.e., an engine without a third stream (e.g., fan stream 172 in the exemplary engine 100 of FIG. 2). With such a configuration, a total sea level static thrust output Fn_{Total} of the engine 100 may generally be equal to a sum of: a fan stream thrust Fn_{Fan} (i.e., an amount of thrust generated by a fan 152 through a bypass passage 194) and a turbomachine thrust Fn_{TM} (i.e., an amount of thrust generated by an airflow through a turbomachine exhaust nozzle 140), each during the static, sea level, standard day conditions.

Further, for the exemplary embodiment of FIG. 8, the engine 100 additionally includes a cooled cooling air system 250 configured to provide a turbine section with cooled cooling air during operation of the engine 100, to allow the engine 100 to accommodate higher temperatures to allow for a reduction in a high pressure compressor exit area, while maintaining or even increasing a maximum turbofan engine thrust output.

It will be appreciated that in other exemplary embodiments of the present disclosure, the cooled cooling air system 250 of the engine 100 may be configured in any other suitable manner. For example, the exemplary cooled cooling air system 250 described above with reference to FIGS. 2 and 3 is generally configured as a thermal bus cooled cooling air system. However, in other embodiments, the cooled cooling air system 250 may instead be a dedicated heat exchanger cooled cooling air system (i.e., a cooled cooling air system including a heat exchanger that transfers heat directly to a cooling medium). Additionally, in other embodiments, the cooled cooling air system 250 may be a bypass heat exchanger cooled cooling air system having a heat sink heat exchanger thermally coupled to an airflow through a bypass passage (see, e.g., FIG. 9, discussed below). Additionally, or alternatively, in other embodiments, the cooled cooling air system 250 may be one of an air-to-air cooled cooling air system (a cooled cooling air system having a heat sink heat exchanger configured to transfer heat to an airflow; see, e.g., FIG. 9, discussed below); an oil-to-air cooled cooling air system (a cooled cooling air system having a heat sink heat exchanger configured to transfer heat to an oil flow); or a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc.; see, e.g., FIG. 4).

More particularly, referring generally to FIGS. 9 through 11, in other exemplary embodiments, the cooled cooling air system 250 of the engine 100 may be configured in any other suitable manner. The exemplary engines 100 depicted in FIGS. 9 through 11 may be configured in a similar manner as exemplary engine 100 described above with reference to FIGS. 1 through 4, and the same or similar numbers may refer to the same or similar parts.

For example, each of the exemplary engines 100 depicted in FIGS. 9 through 11 generally includes a turbomachine 120 having an LP compressor 126, an HP compressor 128, a combustion section 130, an HP turbine 132, and an LP turbine 134 collectively defining at least in part a working gas flowpath 142 and arranged in serial flow order. The exemplary turbomachine 120 depicted additionally includes a core cowl 122, and the engine 100 includes a fan cowl 170. The engine 100 includes or defines a fan duct 172 positioned partially between the core cowl 122 and the fan cowl 170. Moreover, a bypass passage 194 is defined at least in part by the core cowl 122, the fan cowl 170, or both and extends over the turbomachine 120.

Moreover, the exemplary engines 100 depicted in FIGS. 9 to 11 additionally include a cooled cooling air system 250. The cooled cooling air system 250 generally includes a duct assembly 252 and a CCA heat exchanger 254.

However, referring particular to FIG. 9, it will be appreciated that for the exemplary embodiment depicted, the CCA heat exchanger 254 is positioned in thermal communication with the bypass passage 194, and more specifically, it is exposed to an airflow through or over the bypass passage 194. For the embodiment of FIG. 9, the CCA heat exchanger 254 is positioned on the core cowl 122. In such a manner, the CCA heat exchanger 254 may be an air-to-air CCA heat exchanger configured to exchange heat between an airflow extracted from the HP compressor 128 and the airflow through the bypass passage 194.

As is depicted in phantom, the cooled cooling air system 250 may additionally or alternatively be positioned at any other suitable location along the bypass passage 194, such as on the fan cowl 170. Further, although depicted in FIG. 9 as being positioned on the core cowl 122, in other embodiments, the CCA heat exchanger 254 may be embedded into the core cowl 122, and airflow through the bypass passage 194 may be redirected from the bypass passage 194 to the CCA heat exchanger 254.

As will be appreciated, a size of the CCA heat exchanger 254 may affect the amount of drag generated by the CCA heat exchanger 254 being positioned within or exposed to the bypass passage 194. Accordingly, sizing the cooled cooling air system 250 in accordance with the present disclosure may allow for a desired reduction in a HP compressor 128 exit area, while maintaining or even increasing a total thrust output for the engine 100, without creating an excess amount of drag on the engine 100 in the process.

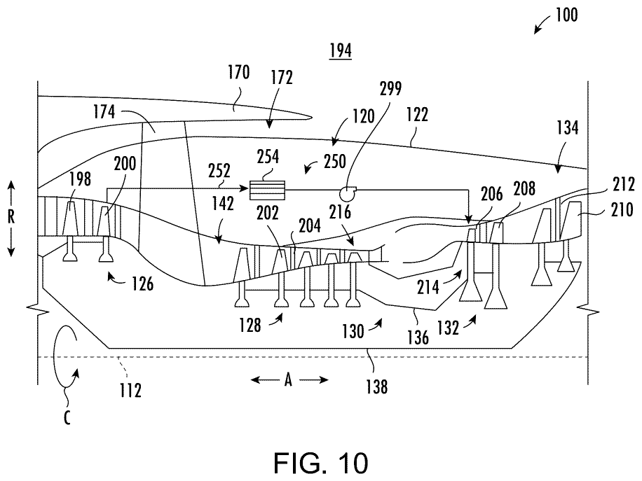

Referring now particular to FIG. 10, it will be appreciated that for the exemplary embodiment depicted, the cooled cooling air system 250 is configured to receive the cooling airflow from an air source upstream of a downstream half of the HP compressor 128. In particular, for the exemplary embodiment of FIG. 10, the exemplary cooled cooling air system 250 is configured to receive the cooling airflow from a location upstream of the HP compressor 128, and more specifically, still, from the LP compressor 126. In order to allow for a relatively low pressure cooling airflow to be provided to a first stage 214 of HP turbine rotor blades 206 of the HP turbine 132, the cooled cooling air system 250 further includes a pump 299 in airflow communication with the duct assembly 252 to increase a pressure of the cooling airflow through the duct assembly 252. For the exemplary aspect depicted, the pump 299 is positioned downstream of the CCA heat exchanger 254. In such a manner, the pump 299 may be configured to increase the pressure of the cooling airflow through the duct assembly 252 after the cooling airflow has been reduced in temperature by the CCA heat exchanger 254. Such may allow for a reduction in wear on the pump 299.

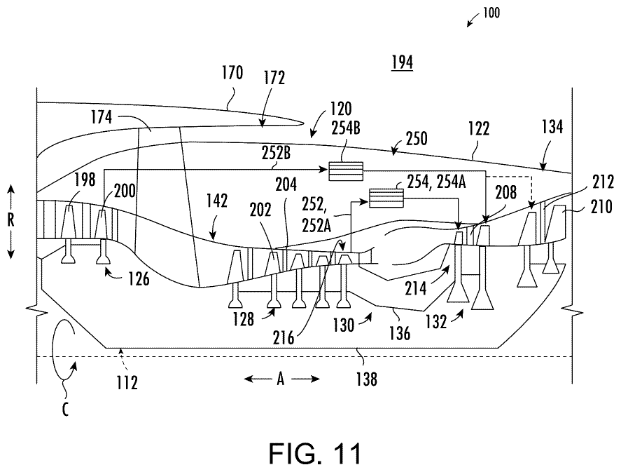

Referring now particularly to FIG. 11, it will be appreciated that the cooled cooling air system 250 includes a high-pressure portion and a low-pressure portion operable in parallel. In particular, the duct assembly 252 includes a high-pressure duct assembly 252A and a low-pressure duct assembly 252B, and the CCA heat exchanger 254 includes a high-pressure CCA heat exchanger 254A and a low-pressure CCA heat exchanger 254B.

The high-pressure duct assembly 252A is in fluid communication with the HP compressor 128 at a downstream half of the high-pressure compressor and is further in fluid communication with a first stage 214 of HP turbine rotor blades 206. The high-pressure duct assembly 252A may be configured to receive a high-pressure cooling airflow from the HP compressor 128 through the high-pressure duct assembly 252A and provide such high-pressure cooling airflow to the first stage 214 of HP turbine rotor blades 206. The high-pressure CCA heat exchanger 254A may be configured to reduce a temperature of the high-pressure cooling airflow through the high-pressure duct assembly 252A at a location upstream of the first stage 214 of HP turbine rotor blades 206.

The low-pressure duct assembly 252B is in fluid communication with a location upstream of the downstream half of the high-pressure compressor 128 and is further in fluid communication with the HP turbine 132 and a location downstream of the first stage 214 of HP turbine rotor blades 206. In particular, for the embodiment depicted, the low-pressure duct assembly 252B is in fluid communication with the LP compressor 126 and a second stage (not labeled) of HP turbine rotor blades 206. The low-pressure duct assembly 252B may be configured to receive a low-pressure cooling airflow from the LP compressor 126 through the low-pressure duct assembly 252B and provide such low-pressure cooling airflow to the second stage of HP turbine rotor blades 206. The low-pressure CCA heat exchanger 254B may be configured to reduce a temperature of the low-pressure cooling airflow through the low-pressure duct assembly 252B upstream of the second stage of HP turbine rotor blades 206.

Inclusion of the exemplary cooled cooling air system 250 of FIG. 11 may reduce an amount of resources utilized by the cooled cooling air system 250 to provide a desired amount of cooling for the turbomachine 120.

Further, for the exemplary embodiment of FIG. 11, it will be appreciated that the cooled cooling air system 250 may further be configured to provide cooling to one or more stages of LP turbine rotor blades 210, and in particular to a first stage (i.e., upstream-most stage) of LP turbine rotor blades 210. Such may further allow for, e.g., the higher operating temperatures described herein.

Reference will now be made briefly to FIG. 12. FIG. 12 provides a schematic view of an engine 500 in accordance with another exemplary embodiment of the present disclosure. The exemplary embodiment of FIG. 12 may be configured in substantially the same manner as the exemplary engine 100 described above with respect to FIGS. 1 through 4, and the same or similar reference numerals may refer to the same or similar parts. However, as will be appreciated, for the embodiment shown, the engine 500 is configured as a three-spool engine, instead of a two-spool engine.

For example, the exemplary engine 500 includes a fan section 502 and a turbomachine 504. The fan section includes a fan 506. The turbomachine includes a first compressor 508, a second compressor 510, a combustion section 512, a first turbine 514, a second turbine 516, and a third turbine 518. The first compressor 508 may be a high pressure compressor, the second compressor 510 may be a medium pressure compressor (or intermediate pressure compressor), the first turbine 514 may be a high pressure turbine, the second turbine 516 may be a medium pressure turbine (or intermediate pressure turbine), and the third turbine 518 may be a low pressure turbine. Further, the engine 500 includes a first shaft 520 extending between, and rotatable with both of, the first compressor 508 and first turbine 514; a second shaft 522 extending between, and rotatable with both of, the second compressor 510 and second turbine 516; and a third shaft 524 extending between, and rotatable with both of, the third turbine 518 and fan 506. In such a manner, it will be appreciated that the engine 500 may be referred to as a three-spool engine.

For the embodiment of FIG. 12, the term redline EGT refers to a maximum temperature of an airflow after the first stator downstream of the last stage of rotor blades of the intermediate speed turbine, e.g., at location 526 in FIG. 12 (assuming the intermediate speed turbine 516 includes a stage of stator vanes downstream of the last stage of rotor blades).

It will further be appreciated that the exemplary cooled cooling air systems 250 described hereinabove are provided by way of example only. In other exemplary embodiments, aspects of one or more of the exemplary cooled cooling air systems 250 depicted may be combined to generate still other exemplary embodiments. For example, in still other exemplary embodiments, the exemplary cooled cooling air system 250 of FIGS. 2 through 4 may not be utilized with a thermal transport bus (e.g., thermal transport bus 300), and instead may directly utilize a CCA heat exchanger 254 positioned within the fan duct 172. Similarly, in other example embodiment, the exemplary cooled cooling air systems 250 of FIGS. 9 through 11 may be utilized with a thermal transport bus (e.g., thermal transport bus 300 of FIG. 2, 4 or 5) to reject heat for the CCA heat exchanger 254. Additionally, although the exemplary cooled cooling air systems 250 depicted schematically in FIGS. 9 through 11 depict the duct assembly 252 as positioned outward of the working gas flow path 142 along the radial direction R, in other exemplary embodiments, the duct assemblies 252 may extend at least partially inward of the working gas flow path 142 along the radial direction R (see, e.g., FIG. 4). In still other exemplary embodiments, the cooled cooling air system 250 may include duct assemblies 252 positioned outward of the working gas flow path 142 along the radial direction R and inward of the working gas flow path 142 along the radial direction R (e.g., in FIG. 11, the high-pressure duct assembly 252A may be positioned inwardly of the working gas flow path 142 along the radial direction R and the low-pressure duct assembly 252B may be positioned outwardly of the working gas flow path 142 along the radial direction R).

Moreover, it will be appreciated that in still other exemplary aspects, the gas turbine engine may include additional or alternative technologies to allow the gas turbine engine to accommodate higher temperatures while maintaining or even increasing the maximum turbofan engine thrust output, as may be indicated by a reduction in the high pressure compressor exit area, without, e.g., prematurely wearing on various components within the turbomachine exposed to the working gas flowpath.

For example, in additional or alternative embodiments, a gas turbine engine may incorporate advanced materials capable of withstanding the relatively high temperatures at downstream stages of a high pressure compressor exit (e.g., at a last stage of high pressure compressor rotor blades), and downstream of the high pressure compressor (e.g., a first stage of an HP turbine, downstream stages of the HP turbine, an LP turbine, an exhaust section, etc.).

In particular, in at least certain exemplary embodiments, a gas turbine engine of the present disclosure may include an airfoil (e.g., rotor blade or stator vane) in one or more of the HP compressor, the first stage of the HP turbine, downstream stages of the HP turbine, the LP turbine, the exhaust section, or a combination thereof formed of a ceramic-matrix-composite or “CMC.” As used herein, the term CMC refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al2O3), silicon dioxide (SiO2), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al2O3), silicon dioxide (SiO2), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC-SiN for silicon carbide fiber-reinforced silicon carbide/silicon nitride matrix mixture, etc. In other examples, the CMCs may include a matrix and reinforcing fibers comprising oxide-based materials such as aluminum oxide (Al2O3), silicon dioxide (SiO2), aluminosilicates, and mixtures thereof. Aluminosilicates can include crystalline materials such as mullite (3Al2O3 2SiO2), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

One or more of these components formed of a CMC material may include an environmental-barrier-coating or “EBC.” The term EBC refers to a coating system including one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., including barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

In such a manner, it will be appreciated that the EBCs may generally be suitable for application to “components” found in the relatively high temperature environments noted above. Examples of such components can include, for example, combustor components, turbine blades, shrouds, nozzles, heat shields, and vanes.

Additionally, or alternatively still, in other exemplary embodiments, a gas turbine engine of the present disclosure may include an airfoil (e.g., rotor blade or stator vane) in one or more of an HP compressor, a first stage of an HP turbine, downstream stages of the HP turbine, an LP turbine, an exhaust section, or a combination thereof formed in part, in whole, or in some combination of materials including but not limited to titanium, nickel, and/or cobalt based superalloys (e.g., those available under the name Inconel® available from Special Metals Corporation). One or more of these materials are examples of materials suitable for use in an additive manufacturing processes.

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 4 and 8 through 11. The method includes operating the gas turbine engine at a takeoff power level, the gas turbine engine having a turbomachine with a high pressure compressor defining a high pressure compressor exit area (A_{HPCExit}) in square inches. The gas turbine engine further defines a redline exhaust gas temperature (EGT) in degrees Celsius, a total sea level static thrust output (Fn_{Total}) in pounds, and a corrected specific thrust. The corrected specific thrust is greater than or equal to 42 and less than or equal to 90, the corrected specific thrust determined as follows: Fn_{Total}×EGT/(A_{HPCExit}²×1000).

In certain exemplary aspects, operating the gas turbine engine at the takeoff power level further includes reducing a temperature of a cooling airflow provided to a high pressure turbine of the gas turbine engine with a cooled cooling air system. For example, in certain exemplary aspects, reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

As will be appreciated from the description herein, various embodiments of a gas turbine engine are provided. Certain of these embodiments may be an unducted, single rotor gas turbine engine (see FIG. 1), a turboprop engine, or a ducted turbofan engine (see FIG. 8). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the FIGS.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 3.2 to 12 or within a range of 4.5 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 6 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

In various exemplary aspects of the present disclosure, a three-stream gas turbine engine is provided that includes at least one component comprising a nickel-based superalloy. Notably, the inventors of the present disclosure have found that certain architectural arrangements of the three-stream gas turbine engine with a component comprising a nickel-based superalloy can provide advantages over conventional gas turbine engines.

For example, incorporating the component comprising a nickel-based superalloy in the gas turbine engine can allow for the gas turbine engine to increase efficiency by, e.g., providing particular properties to the component or components within particular sections of the engine that may increase efficiency. For example, the properties of the component(s) comprising a nickel-based superalloy may have a combination of desirable properties, such as reduced weight, tailored strength properties, tailored creep properties (particularly for rotatory components), tailored thermal properties (e.g., capable of use in hotter conditions), tailored stress properties, etc. The composition of the nickel-based superalloy may also be tailored to the particular component. In one embodiment, for example, a component including the nickel-based superalloy may be capable of running within the gas turbine engine at the same stress conditions but at hotter temperatures than components formed from other materials.

Suitable nickel-based superalloy compositions and microstructures for a given component are dependent on the particular temperatures, stresses, and other conditions to which the component is subjected. For example, airfoil components such as blades and vanes may be formed of equiaxed, directionally solidified (DS), or single crystal (SX) superalloys, whereas turbine disks may be formed of superalloys that undergo carefully controlled forging, heat treatments, and surface treatments (e.g., such as peening) to produce a polycrystalline microstructure having a controlled grain structure and desirable mechanical properties.

Turbine disks may be formed of gamma prime (γ′) precipitation-strengthened nickel-based superalloys (hereinafter, gamma prime nickel-based superalloys) containing chromium, tungsten, molybdenum, rhenium and/or cobalt as principal elements that combine with nickel to form the gamma (γ) matrix, and contain aluminum, titanium, tantalum, niobium, and/or vanadium as principal elements that combine with nickel to form the desirable gamma prime precipitate strengthening phase, principally Ni₃(Al,Ti). Particularly notable gamma prime nickel-based superalloys include René 88DT (R88DT; U.S. Pat. No. 4,957,567) and René 104 (R104; U.S. Pat. No. 6,521,175), as well as certain nickel-based superalloys commercially available under the trademarks Inconel®, Nimonic®, and Udimet®. R88DT has a composition of, by weight, 15.0-17.0% chromium, 12.0-14.0% cobalt, 3.5-4.5% molybdenum, 3.5-4.5% tungsten, 1.5-2.5% aluminum, 3.2-4.2% titanium, 0.5.0-1.0% niobium, 0.010-0.060% carbon, 0.010-0.060% zirconium, 0.010-0.040% boron, 0.0-0.3% hafnium, 0.0-0.01 vanadium, and 0.0-0.01 yttrium, the balance nickel and incidental impurities. R104 has a nominal composition of, by weight, 16.0-22.4% cobalt, 6.6-14.3% chromium, 2.6-4.8% aluminum, 2.4-4.6% titanium, 1.4-3.5% tantalum, 0.9-3.0% niobium, 1.9-4.0% tungsten, 1.9-3.9% molybdenum, 0.0-2.5% rhenium, 0.02-0.10% carbon, 0.02-0.10% boron, 0.03-0.10% zirconium, the balance nickel and incidental impurities.

Disks and other critical gas turbine engine components may be forged from billets produced by powder metallurgy (P/M), conventional cast and wrought processing, and spraycast or nucleated casting forming techniques. Gamma prime nickel-based superalloys formed by powder metallurgy are particularly capable of providing a good balance of creep, tensile, and fatigue crack growth properties to meet the performance requirements of turbine disks and certain other gas turbine engine components.

In particular, the inventors of the present disclosure found that by incorporating the component(s) comprising a nickel-based superalloy in the gas turbine engine, in combination with one or more of the embodiments described hereinabove can result in an engine being capable of operating within the desired parameters (e.g., temperature, pressure, rotational speeds, etc.).

Furthermore, disclosed hereinbelow are exemplary nickel-based superalloys that may form a component or components within the engine. Thus, such a gas turbine engine can exhibit enhanced operability during certain mission requirements by designing the gas turbine engine to include the component(s) comprising a nickel-based superalloy.

Particular embodiments of nickel-based superalloy compositions are provided, and more particularly nickel-based superalloys suitable for components requiring a polycrystalline microstructure and high temperature dwell capability, for example, turbine disks of gas turbine engines. In certain embodiments, the nickel-based superalloy compositions exhibit desired and balanced improvements in creep and hold time (dwell) fatigue crack growth rate characteristics at temperatures of 1200° F. (about 650° C.) and higher, while also having good producibility and thermal stability.

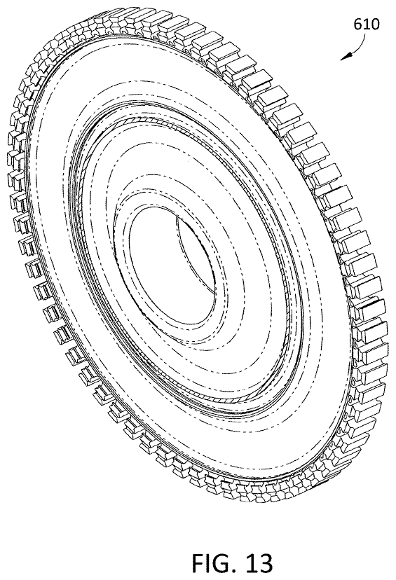

Embodiments of nickel-based superalloys may include gamma prime nickel-based superalloys, and particular those suitable for components produced by a hot working (e.g., forging) operation to have a polycrystalline microstructure. A particular example, represented in FIG. 13, is a high pressure turbine disk 610 for a gas turbine engine, such as discussed above with respect to FIG. 1. Although discussed in reference to processing of a high-pressure turbine disk for such a gas turbine engine, though those skilled in the art will appreciate that the teachings and benefits of this invention are also applicable to compressor disks and bladed disks (i.e., “blisks”) of gas turbine engines, as well as numerous other components that are subjected to stresses at high temperatures and therefore require a high temperature dwell capability.

Disks of the type shown in FIG. 13 are typically produced by isothermally forging a fine-grained billet formed by powder metallurgy (PM), a cast and wrought processing, or a spraycast or nucleated casting type technique. In embodiments utilizing a powder metallurgy process, the billet can be formed by consolidating a superalloy powder, such as by hot isostatic pressing (HIP) or extrusion consolidation. The billet may be forged at a temperature at or near the recrystallization temperature of the alloy but less than the gamma prime solvus temperature of the alloy, and under superplastic forming conditions. After forging, a supersolvus (solution) heat treatment is performed, during which grain growth occurs. The supersolvus heat treatment is performed at a temperature above the gamma prime solvus temperature (but below the incipient melting temperature) of the superalloy to recrystallize the worked grain structure and dissolve (solution) the gamma prime precipitates in the superalloy. Following the supersolvus heat treatment, the component is cooled at an appropriate rate to re-precipitate gamma prime within the gamma matrix or at grain boundaries, so as to achieve the particular mechanical properties desired. The component may also undergo aging using known techniques.

Superalloy compositions may be capable of exhibiting better high temperature dwell capabilities than other nickel-based superalloys. More particularly, the composition may improve tensile, creep, hold time (dwell) crack growth rate, density, and/or other important or desired mechanical properties for turbine disks. In particular, the composition may provide improved creep and hold time fatigue crack growth rate (HTFCGR), which may be suitable for use in a rotating component within a gas turbine engine. Solution temperatures and preferred amounts of gamma prime and carbides were defined to identify compositions with desirable combinations of mechanical properties, phase compositions and gamma prime volume fractions, while avoiding undesirable phases that could reduce in-service capability if equilibrium phases sufficiently form due to in-service environment characteristics. In the investigations, regression equations or transfer functions were developed based on selected data obtained from historical disk alloy development work. The investigations also relied on qualitative and quantitative data of the aforementioned nickel-based superalloys R88DT and R104.

Particular nickel-based superalloy compositions may have a volume percentage of gamma prime ((Ni,Co)₃(Al, Ti, Nb, Ta)) greater than that of R88DT, with the intent to promote strength at temperatures of 1400° F. (about 760° C.) and higher over extended periods of time, along with a gamma prime solvus temperature of not more than 2200° F. (about 1200° C.) for ease of manufacture during heat treatment and quench. Certain compositional elements may be included within such nickel-based superalloy compositions, including hafnium for high temperature strength, chromium levels of 10 weight percent or more for corrosion resistance, aluminum levels greater than the nominal R88DT level to maintain gamma prime (Ni₃(Al, Ti, Nb, Ta)) stability, and cobalt levels of greater than 18 weight percent to aid in minimizing stacking fault energy (desirable for good cyclic behavior), as well as controlling the gamma prime solvus temperature. Additionally, relatively high levels of refractory elements may be desirable to improve high temperature properties, and selective balancing of titanium, tungsten, niobium and molybdenum levels may be employed to optimize creep and hold time fatigue crack growth behavior. Such properties included ultimate tensile strength (UTS) at 1200° F. (about 650° C.), yield strength (YS), elongation (EL), reduction of area (RA), creep (time to 0.2% creep at 1200° F. and 115 ksi (about 650° C. at about 790 MPa), hold time (dwell) fatigue crack growth rate (HTFCGR; da/dt) at 1300° F. (about 700° C.) and a maximum stress intensity of 25 ksi √in (about 27.5 MPa √m), fatigue crack growth rate (FCGR), gamma prime volume percent (GAMMA′ %) and gamma prime solvus temperature (SOLVUS), all of which were evaluated on a regression basis. Units for these properties reported herein are ksi for UTS and YS, percent for EL, RA and gamma prime volume percent, hours for creep, in/sec for crack growth rates (HTFCGR and FCGR), and ° F. for gamma prime solvus temperature. Thermodynamic calculations were also performed to assess alloy characteristics such as phase volume fraction, stability and solvii for gamma prime, carbides, borides and topologically close packed (TCP) phases.

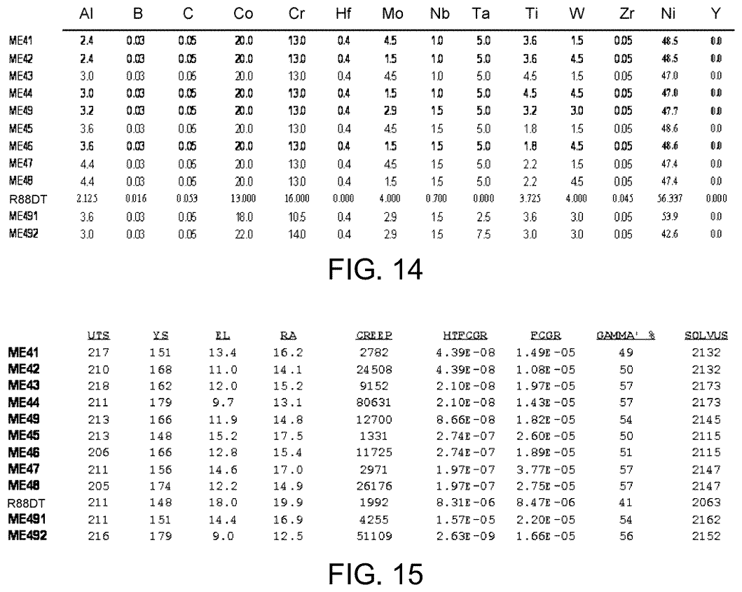

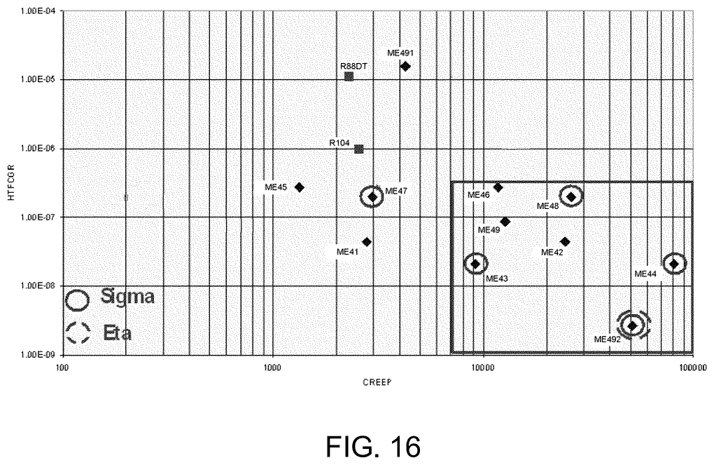

A first series of alloy compositions are defined (by weight percent, wt %) as set forth in the table of FIG. 14. Also included in the table of FIG. 14 is R88DT for reference. Regression-based property predictions for the alloys of FIG. 14 are contained in the table of FIG. 15, and FIG. 16 contains a graph of the hold time fatigue crack growth rate (HTFCGR) and creep data from FIG. 15. From the visual depiction of FIG. 16, it can be seen that alloys ME42, ME43, ME44, ME46, ME48, ME49, and ME492 were analytically predicted to exhibit the best combinations of creep and hold time crack growth rate characteristics, with creep exceeding 7000 hours and HTFCGR of about 1×10⁻⁰⁷ in/s (about 1×10⁻⁰⁶ mm/s) or less, and therefore offering a notable improvement of the regression-based predictions for R88DT, R104, and other current alloys plotted in FIG. 16. Those alloys predicted to have improved dwell fatigue and creep over Rene 88DT were further evaluated by thermodynamic calculations to assess alloy characteristics such as phase volume fraction, stability, and solvii. From this analysis, it was predicted that Alloys ME43, ME44, ME48 and ME492 might be prone to potentially undesirable levels of detrimental topologically close-packed (TCP) phases, such as sigma phase (generally (Fe,Mo)ₓ(Ni,Co)_{y}, where x and y=1 to 7) and/or eta phase (Ni₃Ti).

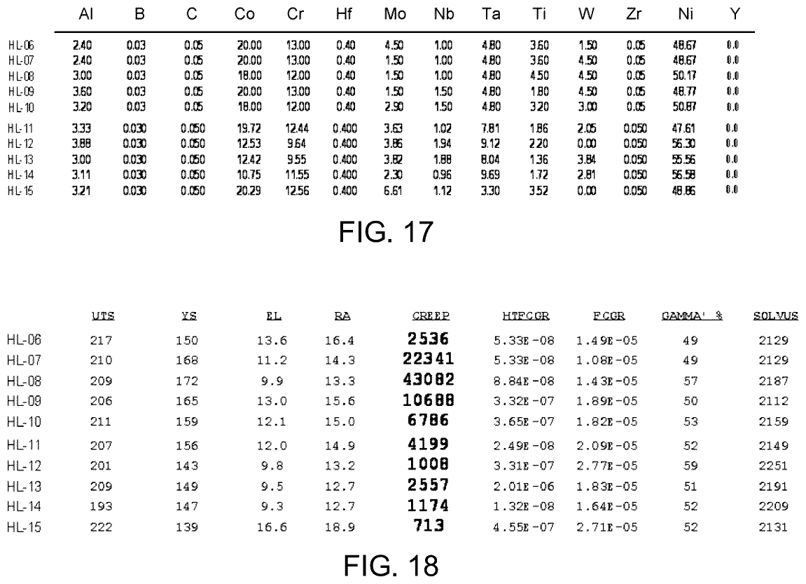

Although the thermodynamic calculations of TCP phases were believed to have some uncertainty, the desire to avoid undesirable levels of formation of TCP phases provided the basis for defining a second series of alloy compositions, designated as alloys HL-06 through HL-15, whose compositions (in weight percent) are summarized in the table of FIG. 17. The second series included a designed experiment-based series of alloys (HL-06,-07,-08,-09 and-10) and a more exploratory-based series of alloys (HL-11,-12,-13,-14 and-15). The designed experiment-based series was largely based on the goal of providing a relatively high tantalum content while balancing Ti/Al and Mo/W+Mo ratios. Four of the five exploratory alloys were formulated to investigate the effect of high tantalum levels, while the fifth (HL-15) was formulated to have a lower tantalum level but a much higher molybdenum level to investigate the affect of offsetting molybdenum for tungsten.

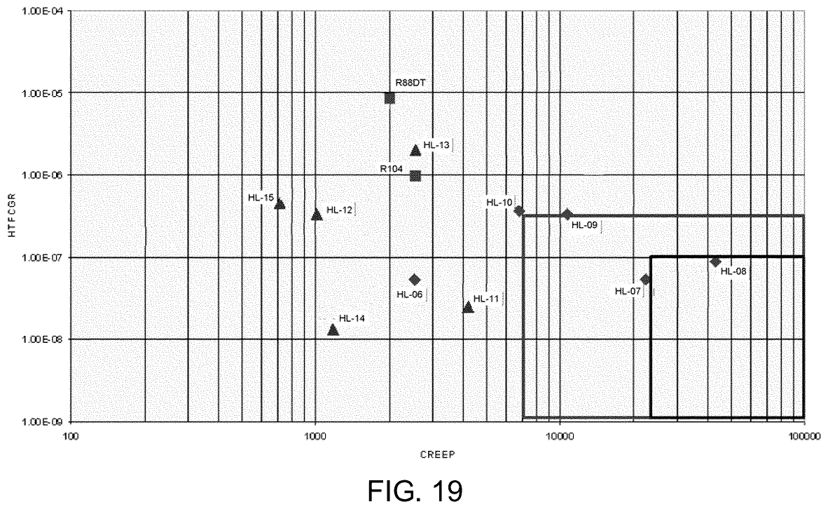

Regression-based property predictions for the second series of alloys are summarized in the table of FIG. 18, and FIG. 19 contains a graph of the HTFCGR and creep data from FIG. 18. From the visual depiction of FIG. 19, it can be seen that alloys HL-07, HL-08 and HL-09 were analytically predicted to exhibit the best combinations of creep and hold time crack growth rate characteristics, with creep exceeding 7000 hours and HTFCGR of about 3×10⁻⁰⁷ in/s (about 7.6×10⁻⁰⁶ mm/s) or less, and therefore offering a notable improvement of the regression-based predictions for R88DT, R104, and other current alloys plotted in FIG. 19. The alloys were also assessed for alloy characteristics such as phase volume fraction, stability and solvii, and none were predicted to have potentially undesirable levels of formation of TCP phases.

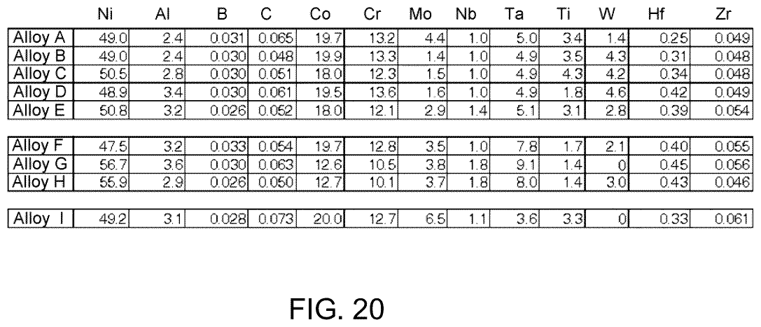

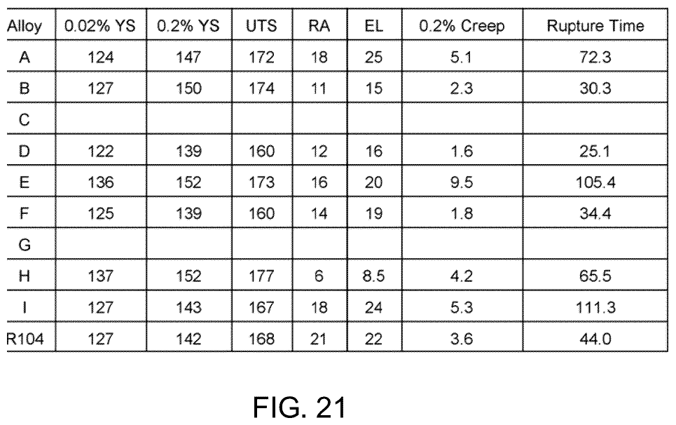

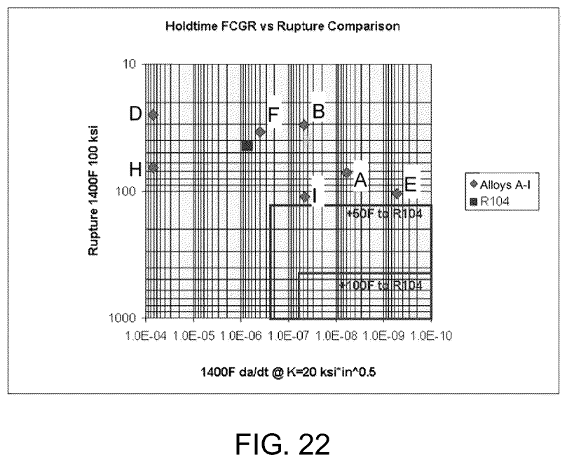

On the basis of the above predictions, nine alloys (Alloys A through I) were prepared with compositions based on the ten alloys of the second series. The actual chemistries (in weight percent) of the prepared alloys are summarized in the table of FIG. 20. From these alloys, two distinguishable alloy types were identified based in part on their different tantalum and molybdenum contents. The first alloy type, encompassing Alloys A through H, is summarized in Table II below and characterized in part by relatively high tantalum levels. The second alloy type, encompassing Alloy I, is summarized in Table III below and characterized by a relatively high molybdenum content. Also summarized in Table II are alloying ranges for the compositions of Alloys A and E, which are believed to have particularly promising properties based on actual performance in a HTFCGR (da/dt) test conducted at 1400° F. and using a three hundred second hold time (dwell) and a maximum stress intensity of 20 ksi √in (about 22 MPa √m). The crack growth rates of Alloys A through I and their crack growth rates relative to R104 are summarized in Table I below. A table provided in FIG. 21 summarizes other properties of Alloys A through I relative to R104. Ultimate tensile strength (UTS) yield strength, (0.02% YS and 0.2% YS), elongation (EL), and reduction of area (RA) were evaluated at 1400° F. (about 760° C.), while time to 0.2% creep (0.2% CREEP) and rupture (RUPTURE TIME) were evaluated at 1400° F. and 100 ksi (about 760° C. at about 690 MPa). It should be noted that the creep and rupture behavior of Alloys A, E and I were significantly higher than those of R104, which itself is considered to exhibit very good creep and rupture behavior. FIG. 22 provides a graph plotting the rupture data of FIG. 21 versus the HTFCGR data of Table I. From the visual depiction of FIG. 22, it can be seen that alloys A, E and I exhibited the best combinations of hold time crack growth rate and rupture, and indicate a notable improvement over R104.

TABLE I

| Alloy | in/sec | Relative crack growth rate |
|---|---|---|
| A | 6.09 × 10⁻⁰⁹ | 0.008 |
| B | 4.83 × 10⁻⁰⁸ | 0.067 |
| C | 1.90 × 10⁻⁰⁷ | 0.263 |
| D | 7.02 × 10⁻⁰⁵ | 97.1 |
| E | 5.43 × 10⁻⁰¹⁰ | 0.001 |
| F | 3.92 × 10⁻⁰⁷ | 0.543 |
| G | 1.88 × 10⁻⁰⁷ | 0.260 |
| H | 7.02 × 10⁻⁰⁵ | 97.1 |
| I | 4.63 × 10⁻⁰⁸ | 0.064 |
| R104 | 7.23 × 10⁻⁰⁷ | 1 |

The titanium: aluminum weight ratio is believed to be important for the alloys of Tables II and III on the basis that higher titanium levels are generally beneficial for most mechanical properties, though higher aluminum levels promote alloy stability necessary for use at high temperatures. In addition, the molybdenum: molybdenum+tungsten weight ratio is also believed to be important for the alloys of Table II as this ratio indicates the refractory content for high temperature response and balances the refractory content of the gamma and the gamma prime phases. As such, these ratios are also included in Tables II and III where applicable. In addition to the elements listed in Tables II and III, it is believed that minor amounts of other alloying constituents could be present without resulting in undesirable properties. Such constituents and their amounts (by weight) include up to 2.5% rhenium, up to 2% vanadium, up to 2% iron, and up to 0.1% magnesium.

TABLE II

| Element | Broad | Narrower | Preferred | Alloy A | Alloy E |
|---|---|---|---|---|---|
| Co | 16.0-30.0 | 17.1-20.9 | 17.1-20.7 | 18.8-20.7 | 17.1-18.9 |
| Cr | 11.5-15.0 | 11.5-14.3 | 11.5-13.9 | 12.6-13.9 | 11.5-12.7 |
| Ta | 4.0-6.0 | 4.4-5.6 | 4.5-5.6 | 4.5-5.5 | 4.6-5.6 |
| Al | 2.0-4.0 | 2.1-3.7 | 2.1-3.5 | 2.1-2.6 | 2.9-3.5 |
| Ti | 1.5 to 6.0 | 1.7-5.0 | 2.8-4.0 | 3.1-3.8 | 2.8-3.4 |
| W | up to 5.0 | 1.0-5.0 | 1.3-3.1 | 1.3-1.6 | 2.5-3.1 |
| Mo | 1.0-7.0 | 1.3-4.9 | 2.6-4.9 | 4.0-4.9 | 2.6-3.2 |
| Nb | up to 3.5 | 0.9-2.5 | 0.9-2.0 | 0.9-1.1 | 1.3-1.6 |
| Hf | up to 1.0 | up to 0.6 | 0.1-0.59 | 0.13-0.38 | 0.20-0.59 |
| C | 0.02-0.20 | 0.02-0.10 | 0.03-0.10 | 0.03-0.10 | 0.03-0.08 |
| B | 0.01-0.05 | 0.01-0.05 | 0.01-0.05 | 0.02-0.05 | 0.01-0.04 |
| Zr | 0.02-0.10 | 0.02-0.08 | 0.02-0.08 | 0.02-0.07 | 0.03-0.08 |
| Ni | Balance | Balance | Balance | Balance | Balance |
| Ti/Al | 0.5-2.0 | 0.54-1.83 | 0.98-1.45 | 1.18-1.45 | 0.98-1.18 |
| Mo/ | 0.24-0.76 | 0.24-0.76 | 0.51-0.76 | 0.71-0.76 | 0.51-0.56 |
| (Mo + W) | | | | | |

TABLE III

| Element | Broad | Narrower | Preferred |
|---|---|---|---|
| Co | 18.0-30.0 | 18.0-22.0 | 18.0-22.0 |
| Cr | 11.4-16.0 | 11.5-16.0 | 11.4-14.0 |
| Ta | up to 6.0 | up to 4.0 | 3.3-4.0 |
| Al | 2.5-3.5 | 2.5-3.5 | 2.8-3.4 |
| Ti | 2.5 to 4.0 | 2.5-4.0 | 3.0-3.6 |
| W | 0.0 | 0.0 | 0.0 |
| Mo | 5.5-7.5 | 5.5-7.5 | 5.8-7.1 |
| Nb | up to 2.0 | up to 2.0 | 1.0-1.2 |
| Hf | up to 2.0 | up to 2.0 | 0.30-0.49 |
| C | 0.04-0.20 | 0.04-0.20 | 0.04-0.11 |
| B | 0.01-0.05 | 0.01-0.05 | 0.01-0.04 |
| Zr | 0.03-0.09 | 0.03-0.09 | 0.03-0.09 |
| Ni | Balance | Balance | Balance |
| Ti/Al | 0.71-1.60 | 0.71-1.60 | 0.88-1.29 |

Though the alloy compositions identified in FIGS. 14, 17 and 20 and the alloys and alloying ranges identified in Tables II and III were initially based on analytical predictions, the extensive analysis and resources relied on to make the predictions and identify these alloy compositions provide a strong indication for the potential of these alloys, and particularly the alloy compositions of Tables II and III, to achieve significant improvements in creep and hold time fatigue crack growth rate characteristics desirable for turbine disks of gas turbine engines.

Particular embodiments of nickel-based superalloy compositions are provided, and more particularly gamma prime nickel-based superalloys, and particular those suitable for components produced by a hot working (e.g., forging) operation to have a polycrystalline microstructure. A particular example represented in FIG. 13 is a high pressure turbine disk 610 for a gas turbine engine, such as discussed above with respect to FIG. 1. Although discussed in reference to processing of a high-pressure turbine disk for such a gas turbine engine, though those skilled in the art will appreciate that the teachings and benefits of this invention are also applicable to compressor disks and blisks of gas turbine engines, as well as numerous other components that are subjected to stresses at high temperatures and therefore require a high temperature dwell capability.

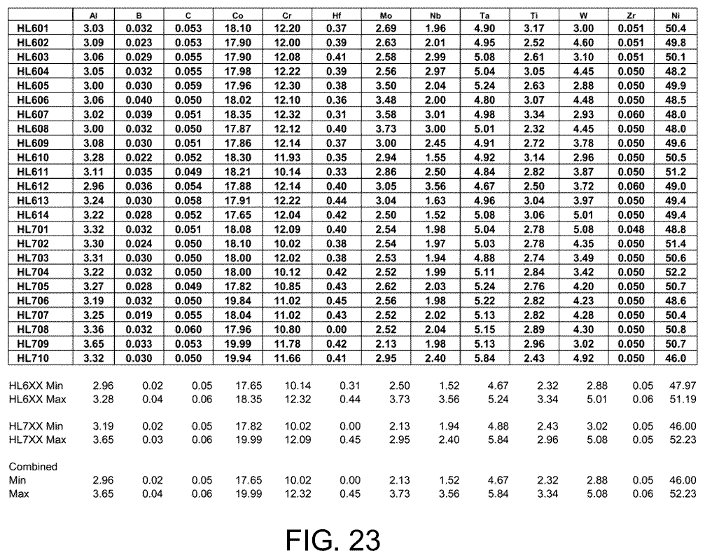

Twenty-four alloy compositions were prepared and evaluated under a series of property tests that included not only high temperature creep at 1300° F. (about 705° C.), but also creep at higher temperatures, ultimate tensile strength (UTS), yield strength (YS), ductility, notched stress rupture (NSR), cycle and dwell fatigue crack growth rate (FCGR), low cycle fatigue (LCF), and sustained-peak low cycle fatigue (SPLCF). The alloy compositions generally fell within two chemistry groups, one of which was identified as HL601 through HL614 (collectively, referred to herein as the HL6XX alloys or alloy series), and the other HL701 through HL710 (collectively, referred to herein as the HL7XX alloys or alloy series). All of the alloys were targeted to have the following nominal levels, by weight, for certain alloy constituents: 3.2% Al; 0.030% B; 0.05% C; 2.5% Mo; 2.8% Ti, and 0.05% Zr. The investigated ranges for cobalt, chromium, niobium, tantalum, and tungsten were varied among the alloys to evaluate their effects on high temperature creep properties and detrimental TCP phases. Nominally, the cobalt levels were targeted to be 18 to 20 wt %; the chromium levels were targeted to be 10 to 12 weight percent; the niobium levels were targeted to be 1.5 to 3.5 weight percent; the tantalum levels were targeted to be 5 to 6 weight percent; and the tungsten levels were targeted to be 3 to 5 weight percent. In addition, one of the HL7XX alloys (HL708) was evaluated with no intentional addition of hafnium. The actual chemistries of the HL6XX and HL7XX alloys are summarized in FIG. 23.

The purpose of the experimental HL6XX and HL7XX alloys was to evaluate the possibility of improving creep properties at high temperatures through modifications of refractory metal content, while avoiding detrimental losses in properties due to TCP formation. Phase formations that occur in multicomponent systems formed of nickel-based superalloy are a complex function of the elemental composition of the system. This is due to the complex thermodynamic interactions prevailing among the elements in a multicomponent system in an n-dimensional space, where n is the number of significant elements in the composition of the alloy. The effects of these interactions create situations wherein, at the same percentage content of an element, different phases can occur as the percentage contents of the other constituent elements vary, even when temperature and pressure are fixed. Due to the complex nature of multicomponent superalloy systems, it is not readily apparent as to what compositional ranges would exhibit improved properties, for example, creep or hold time, without simultaneously causing phase instability resulting in a drastic deterioration of the desired properties.

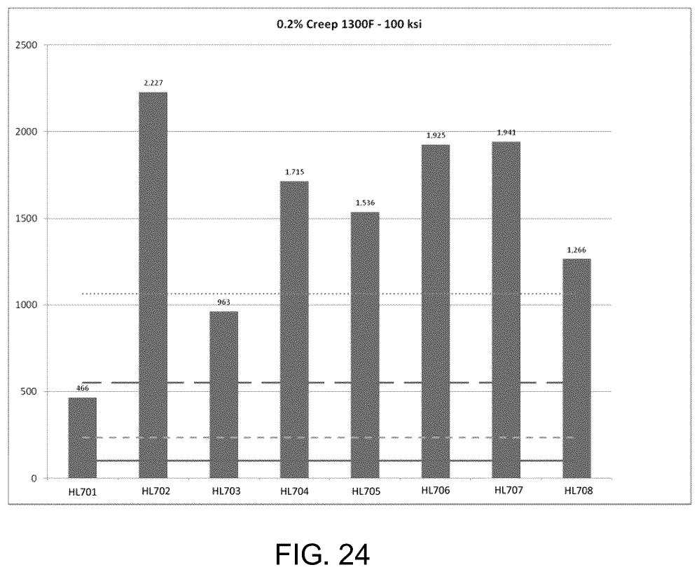

FIG. 24 is a bar graph representing the 0.2% creep at 1300° F. and 100 ksi (about 705° C. and about 690 MPa) of eight of the ten HL7XX alloys: HL701, HL702, HL704-HL708, and HL710. The best performing alloy, HL702, contained a relatively low amount of chromium (10.02 wt %) relative to the targeted chromium range (10 to 12 wt %), whereas the two poorest performing alloys, HL701 and HL703, had relatively high chromium levels (12.09 and 12.02 wt %, respectively). The next five best-performing alloys, HL707, HL706, HL704, HL705, and HL708, had chromium contents of 11.02, 11.02, 10.12, 10.85, and 10.80 wt %, respectively, suggesting that a critical level of chromium may exist between 11.02 and 12.02 wt % within the compositional space of the experimental alloys. The six best-performing alloys had 0.2% creep lives exceeding 1000 hours, whereas HL701 and HL703 had creep lives of less than 1000 hours. The performance of HL701 was attributed to an observable amount of phase instability. Further analysis of these results suggested a positive influence from increasing tungsten and niobium levels in relation to decreasing chromium levels, with the result that their relationship was quantified with the equation W+Nb-Cr. The six best-performing alloys, HL702, HL704, HL705, HL706, HL707, and HL708, had W+Nb-Cr values of −3.7, −4.7, −4.6, −4.8, 4.7, and −4.5, respectively, whereas HL703 had a W+Nb-Cr value of −6.6.

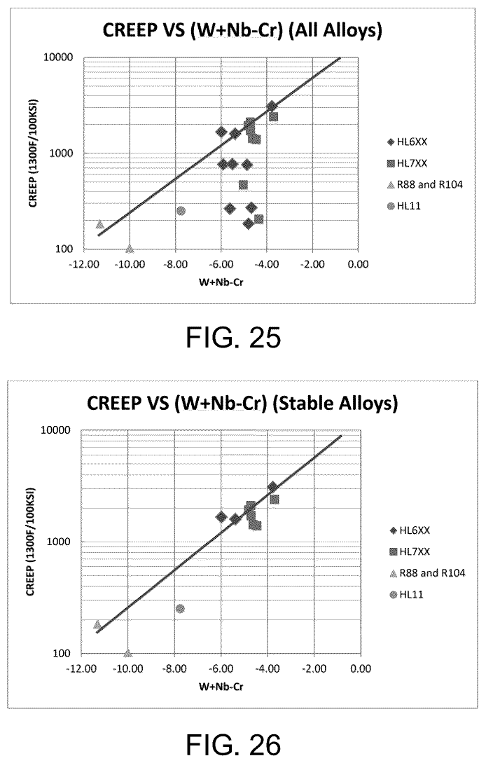

FIG. 25 plots 0.2% creep at 1300° F. and 100 ksi (about 705° C. and about 690 MPa) versus W+Nb-Cr value for nine alloys from the HL6XX series and eight alloys form the HL7XX series that exhibited comparable or improved creep properties compared to the HL11 alloy and the commercial alloys R88DT and R104. The plot shows that these alloys had W+Nb-Cr values of-6.0 or higher (approaching zero), and evidences that many of these HL6XX and HL7XX alloys exceeded HL11, R88DT, and R103 in terms of creep. Eight experimental alloys that had creep lives of less than 1000 hours were determined to be unstable, resulting in observable amounts of TCP phases. FIG. 26 contains the creep data for only the nine alloys whose creep properties were fairly tightly grouped above 1000 hours. This group included HL702, HL704, HL705, HL706, HL707, and HL708, consistent with the better-performing alloys of FIG. 24, as well as HL602, HL603, and HL611. The eight alloys with creep lives below 1000 hours had chromium contents above 11.5 weight percent, more often above 12 weight percent. Because these alloys were determined to contain detrimental TCP phases, particularly sigma and eta phases, their chemistries were concluded to be unstable. Furthermore, creep lives of 1000 hours or more were attributed to the absence of detrimental levels of sigma phase, eta phase, or other TCP phase in the alloys plotted in FIG. 26, which as defined herein refers to the superalloy being free of an observable amount of TCP, as previously defined.

Based on the investigation, the relative amounts of chromium, niobium, and tungsten were concluded to be critical for the purpose of achieving a creep life exceeding HL11 while avoiding observable amounts of sigma, eta, and other detrimental TCP phases. This relationship was concluded to be represented by the W+Nb-Cr value, and that a W+Nb-Cr value of −6 and higher (HL602, HL603, HL611, HL702, HL704, HL705, HL706, HL707 and HL708), was an indicator of a stable alloy that would exhibit a 0.2% creep life at 1300° F. and 100 ksi (about 705° C. and about 690 MPa) in excess of 1000 hours. Creep life and phase stability also appeared to be sensitive to chromium content. Because alloys with a W+Nb-Cr value of −6 and higher included HL602 and HL603 with chromium contents of 12.00 and 12.08%, respectively, a chromium content not exceeding 12.5 wt % was concluded to be acceptable in combination with the ranges of the other alloying constituents, particularly tungsten and niobium. A minimum chromium content was concluded to be 9.5% based on results obtained with alloys having a W+Nb-Cr value of at least −6 and a chromium content of 10% (HL611, HL702, and HL704). Finally, in comparing the compositions of those alloys that performed particularly well (HL602, HL603, HL611, HL702, HL704, HL705, HL706, HL707 and HL708) and the remaining alloys, it was evident that the chromium, molybdenum, niobium, titanium, and tungsten levels all had a significant impact on alloy properties, particularly creep.

It is worth noting that the levels of aluminum, boron, carbon, hafnium, molybdenum, tantalum, titanium, and zirconium were tested at nominal levels. It was concluded that acceptable ranges for these constituents can be broader than what was targeted, and that their levels were not critical as long as their levels were within ranges specified for HL11. The titanium content was concluded to not influence instability at the tested levels of less than 3 weight percent. However, it was concluded that the titanium level should be limited to a maximum of 3.4 weight percent to avoid phase instability. In addition, the levels of molybdenum that were investigated were relatively low, with the intent of reducing the risk of TCP phase formation. Though the level of cobalt was limited to a range of 18 and 20 weight percent, cobalt was not considered to be critical as it freely substitutes for nickel in the gamma phase matrix.

On the basis of the above discussion and the six HL7XX alloys that performed well in FIGS. 24, 25 and 26, alloying ranges for nickel-based superalloy compositions are summarized in Table IV below.

TABLE IV

| Element | Broad | Narrower | Nominal |
|---|---|---|---|
| Co | 16.0-30.0 | 17.0-20.5 | 18.75 |
| Cr | 9.5-12.5 | 10.0-12.5 | 11.25 |
| Ta | 4.0-6.0 | 4.5-5.5 | 5.0 |
| Al | 2.0-4.0 | 3.0-3.4 | 3.2 |
| Ti | 2.0-3.4 | 2.5-2.9 | 2.7 |
| W | 3.0-6.0 | 3.0-5.0 | 4.0 |
| Mo | 1.0-4.0 | 2.5-3.0 | 2.75 |
| Nb | 1.5-3.5 | 1.8-2.2 | 2.0 |
| Hf | up to 1.0 | up to 0.6 | 0.4 |
| C | 0.02-0.20 | 0.048-0.068 | 0.058 |
| B | 0.01-0.05 | 0.015-0.04 | 0.03 |
| Zr | 0.02-0.10 | 0.04-0.06 | 0.05 |
| Ni | Balance | Balance | Balance |
| W + Nb − Cr | ≥−6.0 | ≥−6.0 | ≥−6.0 |

Though the alloy compositions identified in FIG. 23 and the alloys and alloying ranges identified in Table IV were initially based on analytical predictions, the extensive analysis and resources relied on to make the predictions and identify these alloy compositions provide a strong indication for the potential of these alloys, and particularly the alloy compositions of Table IV, to achieve significant improvements in creep and hold time fatigue crack growth rate characteristics desirable for turbine disks of gas turbine engines.

Particular embodiments of nickel-based superalloy compositions are provided, along with articles formed from nickel based alloys and methods of forming the same. In embodiments, the nickel based alloy(s) may have higher temperature strength, creep resistance, fatigue resistance, and environmental resistance without sacrificing processibility, ductility, and fatigue crack growth resistance is desirable in the art.

Components formed from such nickel based alloys may be used at relatively high operating temperatures, and possibly even at higher operating temperatures than currently available commercial alloys. The nickel based alloy may contain various elements, such as cobalt (Co), chromium (Cr), iron (Fe), aluminum (Al), tungsten (W), tantalum (Ta), boron (B), and nickel (Ni). Optionally, the nickel based alloy may also contain other elements, such as carbon (C), hafnium (Hf), zirconium (Zr), or a mixture thereof. Generally, the nickel based alloy is processible into sheet form from cast ingots through wrought processes. The nickel based alloy generally possesses superior high temperature properties, including hold time low cycle fatigue (LCF), tensile properties, creep, and oxidation resistance, compared with other commercially available high temperature wrought alloys, such as Haynes® Alloy 282 (“HA282”), while maintaining acceptable ductility and fatigue crack growth properties.

Generally, the nickel based alloy may possesses unique microstructural features. In certain embodiments, the nickel based alloy is strengthened by gamma-prime precipitates (e.g., gamma-prime Ni₃Al precipitates) in the grain interiors and/or W-bearing precipitates (e.g., Co₂W Laves phase, mu-phase, boride phases, carbide phases) along the grain boundaries. Without intending to be limited by theory, it is believed that the gamma-prime precipitates may contribute to the yield strength, to the ultimate tensile strength and to the creep resistance, all of which are generally higher than prior alloys. In certain embodiments, creep life may be three (3) times that of prior alloys. Furthermore, it is believed that the grain boundary precipitates of W-bearing phases may contribute to ductility and fatigue resistance. The nickel based alloy may have superior hold time LCF resistance compared with prior alloys, due, at least in part, to the combination of the superior creep resistance by gamma-prime precipitates and the grain boundaries strengthened by the precipitation of the Laves phase and other W-bearing phases. Fatigue crack growth threshold and fracture toughness of the nickel based alloy are acceptable for various applications, such as use in gas turbine combustors. In certain embodiments, without the precipitation of the Laves phase and other W-bearing phases along the grain boundaries, the ductility, hold time LCF life, and fracture toughness may become inferior. In some embodiment, the alloy may also contain a small amount of sigma phase and/or beta phases, of which may not harm the properties of the alloy.

The nickel based alloy may contain sufficient aluminum for alumina formation during oxidation and may show far less weight gain or loss during cyclic oxidation compared to prior alloys. The nickel based alloy can be processed into sheet form by hot rolling and is weldable without cracking. In one embodiment, the nickel based alloy may be subjected to solution heat treatment and/or aging treatment. For example, solution heat treatment may be performed by heating the nickel based alloy to a solution temperature that is between its solidus temperature and its gamma prime solvus temperature. The aging treatment may be performed by heating the nickel based alloy to an aging temperature that is below the gamma prime solvus temperature.

In embodiments, the nickel based alloy comprises 30% by volume or more of gamma prime precipitates in the grain interiors. Excluding super fine gamma prime precipitates formed during cooling after aging treatment the nickel base alloy can have 30% to 60% by volume gamma prime precipitates in the grain interiors, 35% to 55% by volume gamma prime precipitates in the grain interiors. In certain embodiments, the nickel base alloy has gamma prime solvus temperature 1900° F. (1038° C.) or greater.

In embodiments, the nickel based alloy has a grain boundary fraction of W-bearing phases 20% by volume or more, preferably 25% or more. Additionally, the nickel based alloy has a grain boundary phase lineal density of 310 precipitates per mm or greater.

In one particular embodiment, the nickel based alloy comprises discrete and fine refractory element bearing precipitates along one or more grain boundaries, such as Laves phase precipitates, mu phase precipitates, sigma phase precipitates, beta phase precipitates, boride phase precipitates, carbide phase precipitates, or mixtures thereof. In one particular embodiment, for instance, the nickel based alloy comprises Laves phase precipitates along one or more grain boundaries. For example, the Laves phase precipitates may be W-bearing precipitates, and may include some mu phase therein/therewith.

As stated, the nickel based alloy may comprise the following elements: nickel, cobalt, chromium, iron, aluminum, tungsten, tantalum, boron, and optionally one or more of carbon, hafnium, and zirconium. Each of these elements is included in a particular concentration such that the resulting nickel based alloy has the desired properties, as discussed above. In certain embodiments, the nickel based alloy comprises: 20 wt. % to 26 wt. % cobalt; 9 wt. % to 13 wt. % chromium; 2 wt. % to 6 wt. % iron; 3.5 wt. % to 6 wt. % aluminum; 9 wt. % to 13 wt. % tungsten; 6 wt. % to 9 wt. % tantalum; 0.06 wt. % to 0.20 wt. % boron; and the balance nickel. Optional components may also be included in such a nickel based alloy, such as up to 0.1% by weight carbon (e.g., greater than 0% by weight to 0.1% carbon, preferably 0.02% by weight to 0.08% by weight carbon), up to 0.5% by weight hafnium (e.g., greater than 0% by weight to 0.5% by weight hafnium), and/or up to 0.1% by weight zirconium (e.g., greater than 0% by weight to 0.1% by weight zirconium).

Without wishing to be bound by any particular theory, within the composition spaces investigated (see e.g., examples 1 and 2 discussed below), it is believed that the relatively high concentrations of iron and boron, combined with the relatively low concentrations of cobalt, leads to the desired properties. In particular, it is believed that the increased amount of iron and boron and the decreased amount of cobalt, leads to the desired microstructure that includes the gamma prime precipitates (e.g., at 30% by volume or more of gamma prime precipitates in the grain interiors, as described above), the grain boundary phase fraction (e.g., of 20% by volume or more of the grain boundary phase fraction), and/or the grain boundary phase lineal density (e.g., of 310 precipitates per mm or greater of the grain boundary phase lineal density.

In more preferred embodiments, the nickel based alloy comprises: 22 wt. % to 24 wt. % cobalt; 10 wt. % to 12 wt. % chromium; 3 wt. % to 5 wt. % iron; 4.0 wt. % to 5.5 wt. % aluminum; 10 wt. % to 12 wt. % tungsten; 7 wt. % to 8 wt. % tantalum; 0.07 wt. % to 0.15 wt. % boron; up to 0.1% by weight carbon (e.g., greater than 0% by weight to 0.1% carbon, preferably 0.02% by weight to 0.08% by weight carbon); up to 0.5% by weight hafnium (e.g., greater than 0% by weight to 0.5% by weight hafnium); and/or up to 0.1% by weight zirconium (e.g., greater than 0% by weight to 0.1% by weight zirconium); with the balance being nickel.

The concentrations of each of these elements may be summarized, as shown in Table V, with all values given in percent by weight (% wt.). It is to be understood that the ranges from the preferred ranges and the more preferred ranges may be combined as desired.

TABLE V

| Element | Preferred Range (% wt.) | More Preferred (% wt.) |
|---|---|---|
| Co | 20 to 26 | 22 to 24 |
| Cr | 9 to 13 | 10 to 12 |
| Fe | 2 to 6 | 3 to 5 |
| Al | 3.5 to 6 | 4 to 5.5 |
| W | 9 to 13 | 10 to 12 |
| Ta | 6 to 9 | 7 to 8 |
| B | 0.06 to 0.20 | 0.07 to 0.15 |
| C | 0 to 0.10 | 0.02 to 0.08 |
| Hf | 0 to 0.50 | greater than 0 to 0.50 |
| Zr | 0 to 0.10 | greater than 0 to 0.10 |
| Ni | Balance | Balance |

Those skilled in the art understand that minor trace amounts of other elements at impurity levels are inevitably present, e.g., in commercially-supplied alloys, or by way of processing techniques. Those impurity-level additions may also be considered as part of the nickel based alloy, as long as they do not detract from the properties of the compositions described herein. As such, in certain embodiments, the nickel based alloy may consist essentially of: 20 wt. % to 26 wt. % cobalt; 9 wt. % to 13 wt. % chromium; 2 wt. % to 6 wt. % iron; 3.5 wt. % to 6 wt. % aluminum; 9 wt. % to 13 wt. % tungsten; 6 wt. % to 9 wt. % tantalum; 0.06 wt. % to 0.20 wt. % boron; up to 0.1% by weight carbon (e.g., greater than 0% by weight to 0.1% carbon, preferably 0.02% by weight to 0.08% by weight carbon), up to 0.5% by weight hafnium (e.g., greater than 0% by weight to 0.5% by weight hafnium), up to 0.1% by weight zirconium (e.g., greater than 0% by weight to 0.1% by weight zirconium), and the balance nickel.

For instance, in a preferred embodiment, the nickel based alloy may consist essentially of: 22 wt. % to 24 wt. % cobalt; 10 wt. % to 12 wt. % chromium; 3 wt. % to 5 wt. % iron; 4.0 wt. % to 5.5 wt. % aluminum; 10 wt. % to 12 wt. % tungsten; 7 wt. % to 8 wt. % tantalum; 0.07 wt. % to 0.15 wt. % boron; up to 0.1% by weight carbon (e.g., greater than 0% by weight to 0.1% carbon, preferably 0.02% by weight to 0.08% by weight carbon); up to 0.5% by weight hafnium (e.g., greater than 0% by weight to 0.5% by weight hafnium); and/or up to 0.1% by weight zirconium (e.g., greater than 0% by weight to 0.1% by weight zirconium); with the balance being nickel.

The presently disclosed nickel based alloys may be used to prepare a variety of components, and are particularly suitable for use in high temperature applications. For instance, the nickel based alloy may be used to prepare components for use in turbomachinery, such as with aviation engines (e.g., turbofan, turbojet, turboprop and turboshaft gas turbine engines), industrial engines, marine engines, and auxiliary power units. In particular embodiments, the nickel based alloys may be used to prepare components for gas turbine engines, such as in high pressure compressors (HPC), fans, boosters, high pressure turbines (HPT), low pressure turbines (LPT), turbine cases, and combustors of both airborne and land-based gas turbine engines. For instance, components such as combustion liners, shrouds, nozzles, blades, etc. may be prepared with the present method and materials.

Methods are also generally provided for forming a nickel based alloy and for articles formed form the nickel based alloy. The nickel based alloys may be prepared by way of any of the various traditional methods of metal production and forming. For instance, the nickel based alloy may be prepared by traditional wrought alloy techniques, traditional casting, powder metallurgical processing, directional solidification, single-crystal solidification, additive manufacturing, and combinations thereof. Thermal and thermo-mechanical processing and cold/warm working and forming techniques common in the art for the formation of other alloys may be suitable for use in manufacturing and strengthening the nickel based alloy. The article comprising the nickel based alloy may be prepared by a variety of forging and machining techniques to shape and cut articles formed from the alloy composition. In some embodiments, the nickel based alloy can be formed into a pre-determined shape, and then subjected to a solution treatment, followed by an aging treatment.

The nickel based alloy can be formed into many shapes and articles, e.g., plates, bars, wire, rods, sheets, and the like. The article may be a shape or form that allows for transportation of the alloy from one customer to another. The nickel based alloy is particularly suitable for high temperature articles. Examples include various parts for aeronautical turbines, land-based turbines, and marine turbines. For instance, the nickel based alloy may be used to prepare turbine components, such as vanes, blades, stators, and combustor components, such as combustor liners and transition pieces. However, the nickel based alloy is not limited to such components or uses.

The nickel based alloy can be used to protect other articles or alloy structures. For instance, a layer comprising the nickel based alloy can be attached, deposited or otherwise formed on another alloy structure or part which requires properties characteristic of the nickel based alloy, e.g., environmental resistance and high temperature strength. (The underlying substrate could be formed of a variety of metals and metal alloys, e.g., iron, steel alloys, or other nickel- or cobalt-alloys). The overall product could be considered a composite structure, or a coating, or an “alloy cladding” over a base metal or base metal core. Bonding of the cladding layer to the underlying substrate could be carried out by conventional methods, such as diffusion bonding, hot isostatic pressing, or brazing. Moreover, those skilled in the art would be able to select the most appropriate thickness of the cladding layer, for a given end use, based in part on the teachings herein.

The examples presented below are intended to be merely illustrative and should not be construed to be any sort of limitation on the scope of the claimed invention. Sub-scale heats were produced to screen mechanical and environmental resistance of the alloy as well as hot roll possibility and weldability.

### EXAMPLE 1

The nickel based alloy compositions shown in Table VI were prepared, with all values shown in percent by weight (% wt.). Gamma prime solvus temperatures were measured by differential scanning calorimetry:

TABLE VI
Exemplary Alloy Compositions

| | | | | | | | | | | | | Gamma |
|---|---|---|---|---|---|---|---|---|---|---|---|---|
| | | | | | | | | | | | | prime solvus |
| | wt % | | | | | | | | | | | temperature |
| Alloy | Co | Cr | Fe | Al | W | Ta | B | C | Hf | Zr | Ni | (° C.) |
| 1 | 31.4 | 10.9 | 0.0 | 5.0 | 9.8 | 6.8 | 0.020 | 0.05 | 0.27 | 0.06 | Balance | 1107 |
| 2 | 27.0 | 10.9 | 3.9 | 4.6 | 10.7 | 7.6 | 0.022 | 0.05 | 0.23 | 0.06 | Balance | 1078 |
| 3 | 23.4 | 11.1 | 4.1 | 4.8 | 10.7 | 7.4 | 0.016 | 0.05 | 0.17 | 0.05 | Balance | 1099 |
| 4 | 23.4 | 10.8 | 3.9 | 4.7 | 11.0 | 7.3 | 0.029 | 0.05 | 0.18 | 0.05 | Balance | 1099 |
| 5 | 23.8 | 11.1 | 4.2 | 4.8 | 10.6 | 7.3 | 0.044 | 0.06 | 0.17 | 0.01 | Balance | 1090 |
| 6 | 23.0 | 10.9 | 4.0 | 4.8 | 11.5 | 7.6 | 0.125 | 0.05 | 0.23 | 0.07 | Balance | 1089 |

Each of these nickel based alloys was cast by vacuum induction melting, and formed into sheet by hot rolling, and their respective microstructures were compared after solution heat treatment and aging treatment. The solution was done at a temperature between the solidus and the gamma prime solvus temperatures, and aging treatment was done at a temperature below the gamma prime solvus temperature. As discussed in greater detail below, Alloy 6 was exhibited the most desired combination of properties, particularly the high concentration of fine, discrete

W-bearing precipitates along the grain boundaries and the relatively high concentration of gamma prime precipitates in the grain interiors.

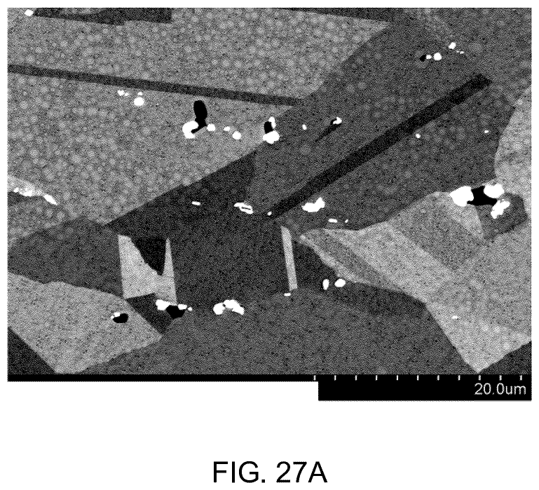

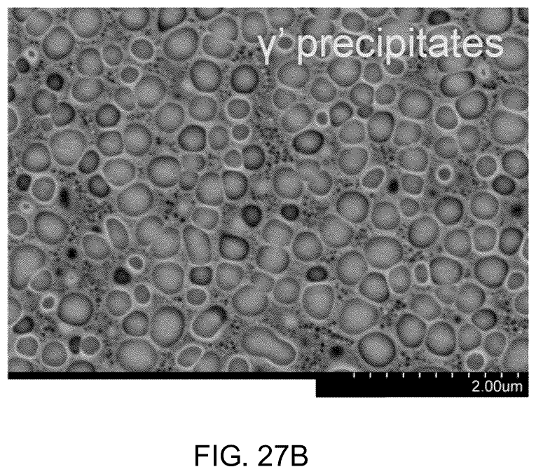

FIGS. 27a and 27 show back-scattered electron SEM images of Alloy 1 from Table VI. FIG. 27a shows that the grain boundaries of the alloy have substantially low amount of W-bearing phases. FIG. 27b shows gamma prime precipitates in the grain interiors.

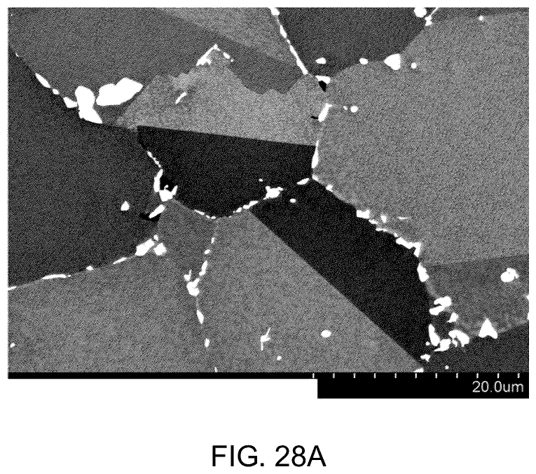

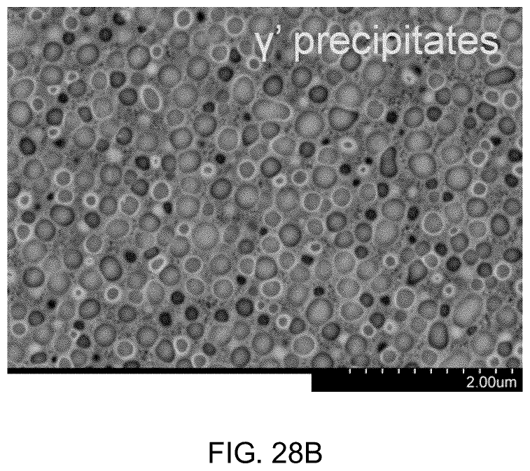

FIGS. 28a and 28b show back-scattered electron SEM images of Alloy 2 from Table VI. FIG. 28a shows that the grain boundaries of the alloy are partly covered with W-bearing phases therein. FIG. 28b shows gamma prime precipitates in the grain interiors.

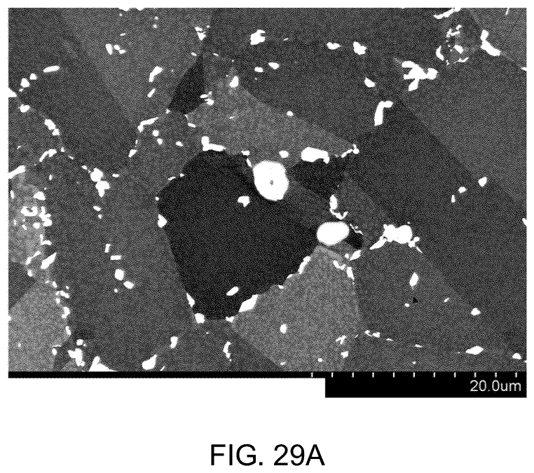

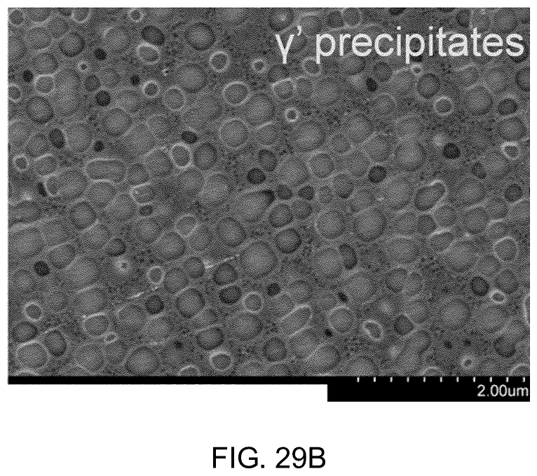

FIGS. 29a and 29b show back-scattered electron SEM images of Alloy 4 from Table VI. FIG. 29a shows that the grain boundaries of the alloy have an increased amount of W-bearing phases therein, compared with Alloy 2. FIG. 29b shows gamma prime precipitates in the grain interiors.

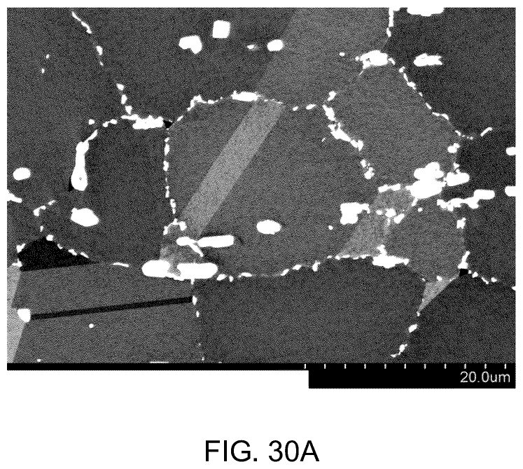

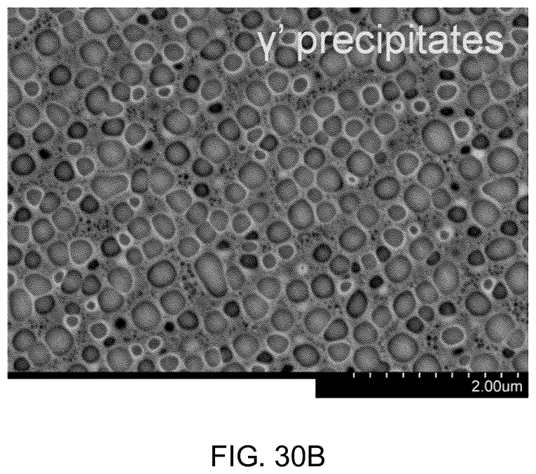

FIGS. 30a and 30b show back-scattered electron SEM images of Alloy 6 from Table VI. FIG. 30a shows that the grain boundaries of the alloy have a higher concentration of fine, discrete W-bearing grain boundary phases therein. FIG. 30b shows gamma prime precipitates in the grain interiors (e.g., greater than 30% by volume).

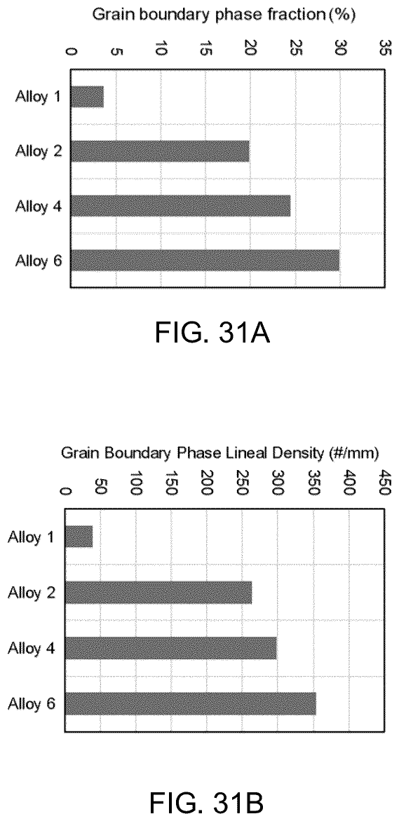

FIG. 31a shows the grain boundary phase fraction of the alloys of Example 1 discussed herein. As shown, reducing Co content and increasing Fe, W, Ta contents in Alloy 1 led to an increased fraction of W-bearing grain boundary phases in Alloy 2. Further reducing Co content in Alloy 2 increased the fraction of W-bearing grain boundary phases in Alloy 4. An addition of higher boron to Alloy 4 resulted in a higher fraction of W-bearing grain boundary phases in Alloy 6. The “Grain Boundary Phase Fraction” was calculated according to the following method. First, at least (2) backscattered electron (BSE) images were obtained using scanning electron microscopy. Using image analysis software, precipitates containing refractory elements (bright contrast in BSE images) were segmented from other features in the image. Additionally, grain boundaries were segmented from other features in the image while excluding twin boundaries. Grain boundaries thinned to 0.2 μm wide bands were consistently segmented, and the total area fraction of the 0.2 μm wide bands (FGB) was measured. Using an image analysis software, the total area fraction of the refractory element bearing precipitates was measured within the 0.2 μm wide bands (FPPT). The grain boundary phase fraction was measured by dividing FPPT by FGB, with the result averaged from multiple images.

FIG. 31b shows the grain boundary phase lineal density of the alloys of Example 1 discussed herein. As shown, Alloy 6 has the highest grain boundary lineal density fraction among the alloys of Example 1. The “Grain Boundary Phase Lineal Density” was calculated according to the following method. First, at least (2) backscattered electron (BSE) images were obtained using scanning electron microscopy. Using image analysis software, precipitates containing refractory elements (bright contrast in BSE images) were segmented from other features in the image. Additionally, grain boundaries were segmented from other features in the image while excluding twin boundaries. Grain boundaries thinned to 0.2 μm wide bands were consistently segmented, and the numbers of grain boundary precipitates were counted in the 0.2 μm wide bands. The grain boundary phase lineal density was calculated by dividing the number of grain boundary precipitates by the total length of the 0.2 μm wide bands, with the results averaged from multiple images.

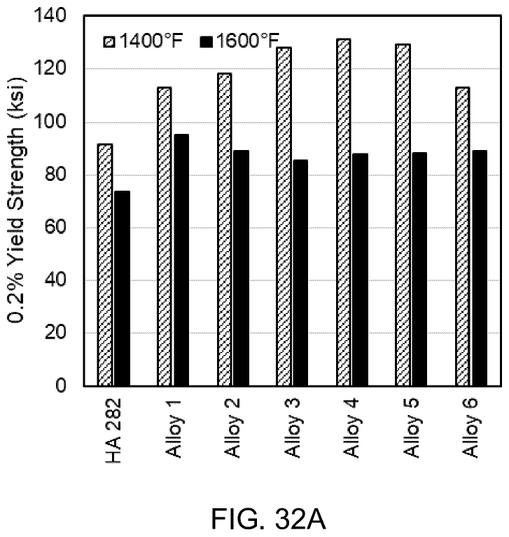

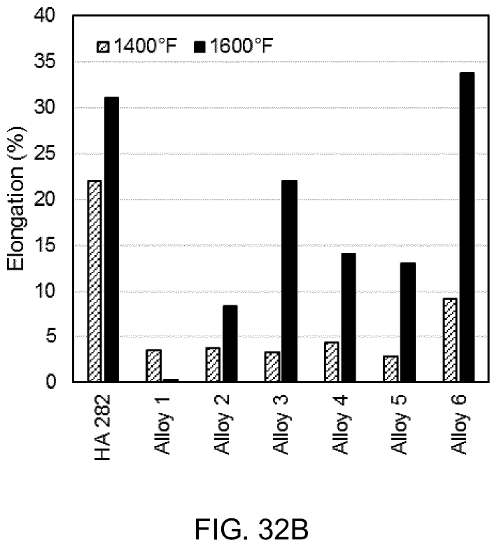

FIGS. 32a and 32b show the tensile properties of the alloys 1-6 compared to Haynes® Alloy 282 (“HA282”). As the data shows, alloys 1-3 show increasing (i.e., improving) elongation at 1600° F. (i.e., about 871° C.), while the elongation at 1400° F. (i.e., about 760° C.) remains consistently low. Additionally, alloys 3-5 show sufficient elongation at 1600° F. (i.e., about 871° C.) but insufficient elongation at 1400° F. (i.e., about 760° C.). Alloy 6 show sufficient elongation at both 1600° F. and 1400° F. as shown in FIG. 32b. As more particularly shown in FIG. 32a, Alloy 6 has improved 0.2% yield strength at higher temperatures of 1400° F. and 1600° F. (i.e., about 871° C.) compared to HA282.

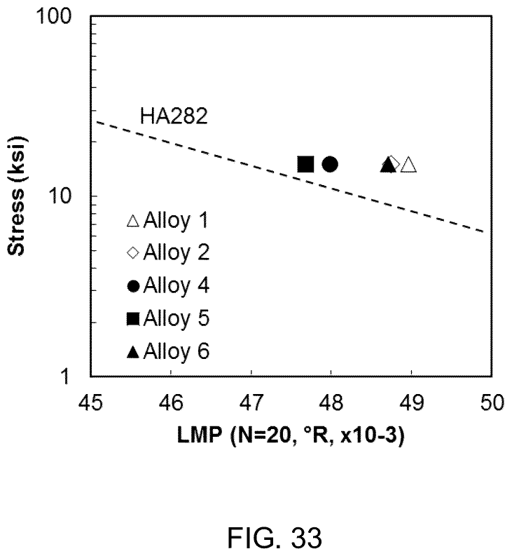

FIG. 33 shows the creep rupture properties of Alloys 1, 2, 4, 5, and 6 compared to HA282. As shown, Alloys 1, 2 and 6 had about 75° F. (i.e., about 24° C.) higher temperature capability compared with HA282. Alloys 4, and 5 had higher temperature capability compared with HA282, but they are inferior to Alloys 1, 2, and 6.

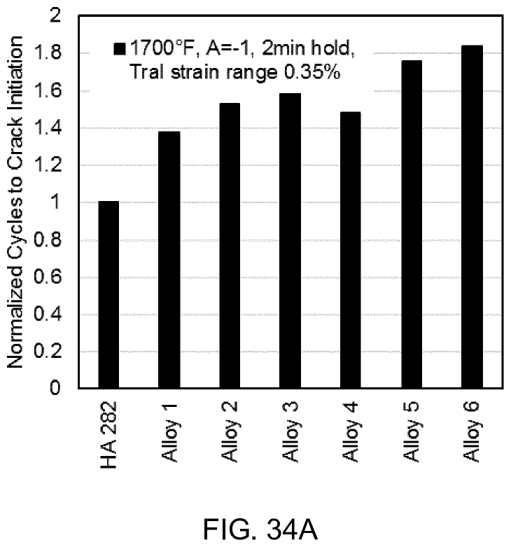

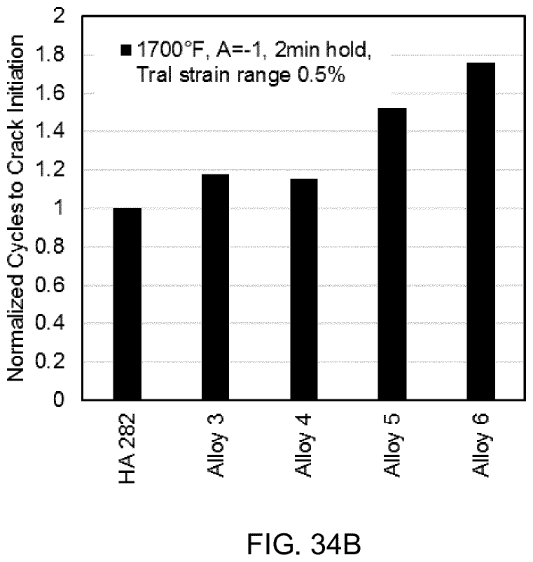

FIGS. 34a and 34b show the hold time low cycle fatigue (LCF) of the alloys 1-6 measured at 1700° F. (i.e., about 927° C.), in comparison to HA282. At low total strain range (e.g., 0.35%), Alloys 1-3 show increasing (i.e., improving) life. Increased boron contents in Alloys 5 and 6 led to longer hold time LCF life. At high total strain range (e.g., 0.5%), Alloys 3 and 4 do not show significant improvement in hold time LCF life, but Alloys 4 and 6 show increasing (improving) life with the addition of boron.

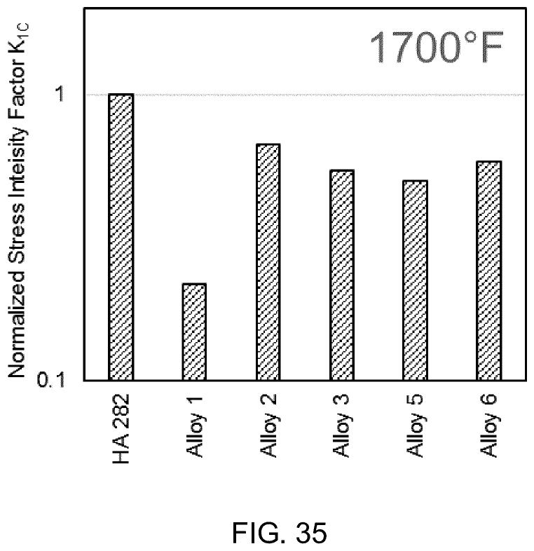

FIG. 35 shows the fracture toughness (K1C) of Alloys 1, 2, 3, 5, and 6 compared to HA282, as measured at 1700° F. (i.e., about 927° C.). As the data shows, Alloy 1 substantially without grain boundary precipitates shows poor fracture toughness. Alloys 2, 3, 5, and 6 with W-bearing grain boundary precipitates have sufficient K1C, while still being lower than HA282.

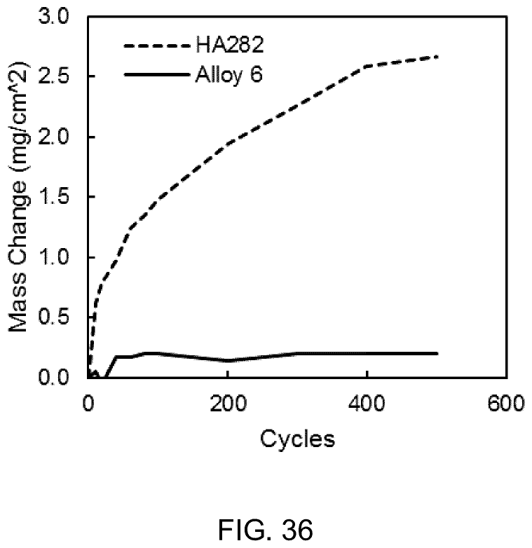

FIG. 36 shows results of a cyclic oxidation test comparing alloy 6 to HA282 at 1800° F. (i.e., about 982° C.) with cycles of 50 minutes in the furnace and 10 minutes out of the furnace. As shown, the mass change of Alloy 6 is minimal compared with HA282 at 1800° F. (i.e., about 982° C.).

### EXAMPLE 2

The range of boron in the nickel based alloy compositions were explored. Keeping all other concentrations the same, the concentration of boron was changed such that the boron concentration increased from 0.064% by weight to 0.166% by weight. The nickel based alloy compositions shown in Table VII were prepared, with all values shown in percent by weight (% wt.):

TABLE VII
Exemplary Alloy Compositions

| | % wt. | | | | | | | | | | |
|---|---|---|---|---|---|---|---|---|---|---|---|
| Alloy | Co | Cr | Fe | Al | W | Ta | B | C | Hf | Zr | Ni |
| A | 23.4 | 10.8 | 3.9 | 4.7 | 11 | 7.3 | 0.064 | 0.05 | 0.2 | 0.05 | Balance |
| B | 23.4 | 10.8 | 3.9 | 4.7 | 11 | 7.3 | 0.083 | 0.05 | 0.2 | 0.05 | Balance |
| C | 23.4 | 10.8 | 3.9 | 4.7 | 11 | 7.3 | 0.109 | 0.05 | 0.2 | 0.05 | Balance |
| D | 23.4 | 10.8 | 3.9 | 4.7 | 11 | 7.3 | 0.140 | 0.05 | 0.2 | 0.05 | Balance |
| E | 23.4 | 10.8 | 3.9 | 4.7 | 11 | 7.3 | 0.149 | 0.05 | 0.2 | 0.05 | Balance |
| F | 23.4 | 10.8 | 3.9 | 4.7 | 11 | 7.3 | 0.166 | 0.05 | 0.2 | 0.05 | Balance |

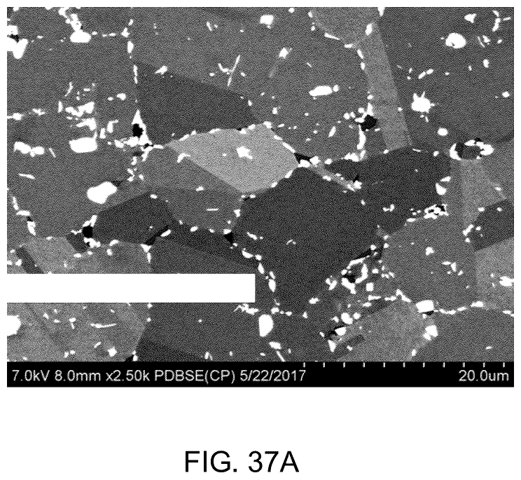

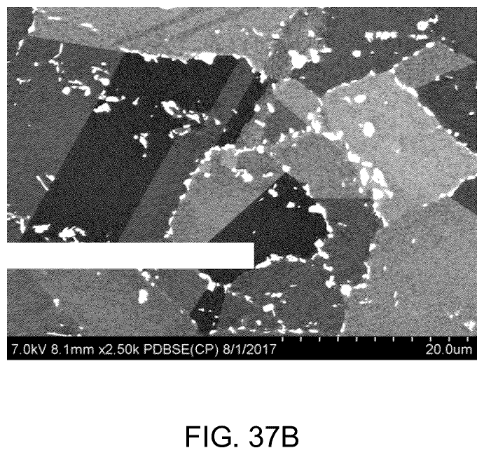

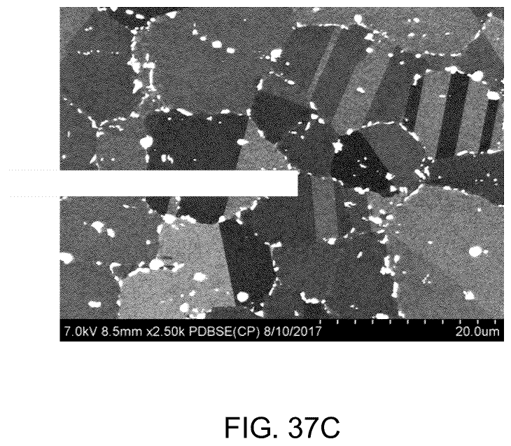

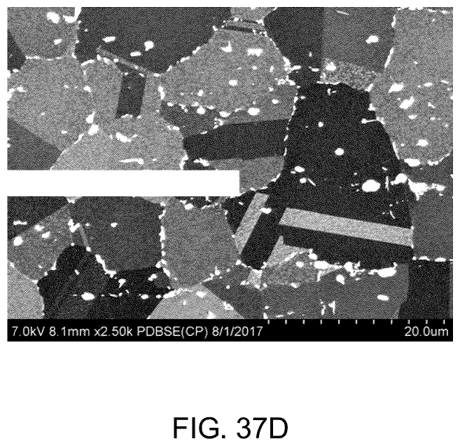

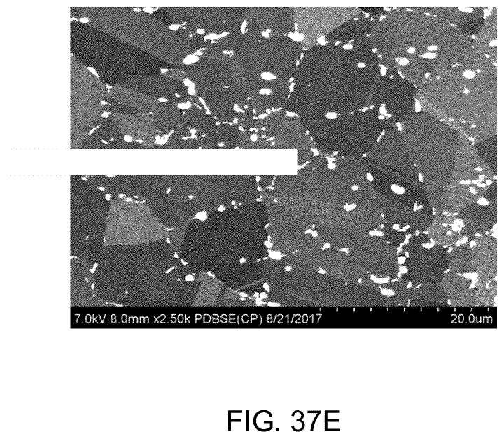

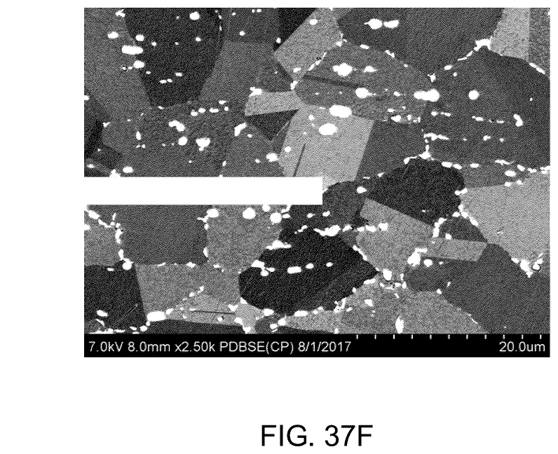

Each of these nickel based alloys was formed into a wrought plate, and their respective microstructures were compared. FIGS. 37a-37f show back-scattered electron SEM images of the alloys A-F, respectively. As shown, alloys A and F showed lower concentration of W-bearing grain boundary phases compared with Alloys B, C, and D. Alloys B, C, and D, exhibited the desired combination of properties, particularly the relatively high amount of W-bearing grain boundary phases along the grain boundaries with fine, discrete forms and the relatively high concentration of gamma prime precipitates in the grain interiors. Alloy E showed slightly less W-bearing grain boundary phases than alloys B, C, and D. The preferred concentration range of boron to form sufficient amount of W-bearing grain boundary phases in fine, discrete morphology was determined to be 0.065 wt. % to 0.155 wt. %, preferably 0.070% by weight to 0.150% by weight.

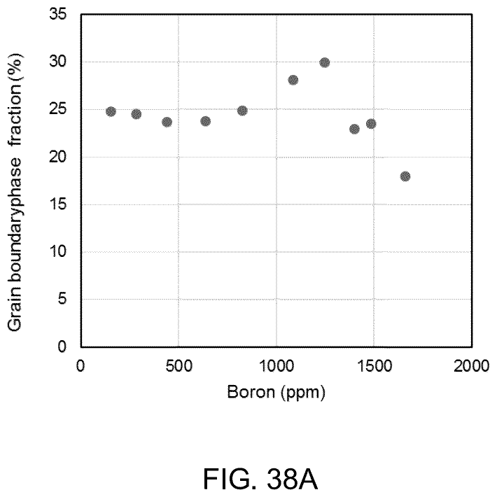

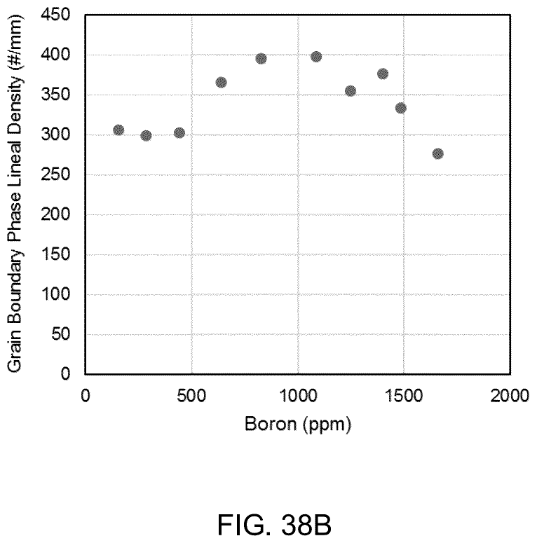

FIG. 38a shows the grain boundary phase fraction of the alloys of Example 2 discussed herein. As shown, the grain boundary phase fraction increases with additions of boron to 1200 ppm, and then decreases with further additions of boron. Sufficient grain boundary phase fraction (e.g., 20% or greater, such as 25% or greater) comparable to that of Alloy 6 can be obtained in alloys with boron concentration up to 0.155 wt %.

FIG. 38b shows the grain boundary phase lineal density of the alloys of Example 2 discussed herein. As shown, similar to the grain boundary phase fraction, the grain boundary phase lineal density increases with additions of boron up to 1200 ppm, then decreases with further additions of boron. Sufficient grain boundary phase fraction (e.g., 300/mm or greater, such as 310/mm or greater) comparable to that of Alloy 6 can be obtained in alloys with boron concentration between 0.065 wt % and 0.155 wt %.

In embodiments, the nickel-based superalloy compositions may be a Ni—Co gamma prime strengthened superalloy that is additively manufacturable so as to form a component designed for operation up to 1000° C. (e.g., 1800° F.) in combustor applications. For example, the nickel-based superalloy compositions may be a Ni—Co gamma prime strengthened superalloy that is an additively manufacturable alloy that enables advanced cooling schemes, ultimately enabling increased SFC. That is, the additively manufacturable alloy based on such a nickel-based superalloy composition may have a desired balance of properties, such as high strength and high fatigue, which may be particularly suitable for advanced engine components, particularly combustion components, such as combustion liners.

That is, the component may be formed as an additively manufacturable nickel based alloy as discussed above, such as comprising: 22 wt. % to 24 wt. % cobalt; 10 wt. % to 12 wt. % chromium; 3 wt. % to 5 wt. % iron; 4.0 wt. % to 5.5 wt. % aluminum; 10 wt. % to 12 wt. % tungsten; 7 wt. % to 8 wt. % tantalum; 0.07 wt. % to 0.15 wt. % boron; up to 0.1% by weight carbon (e.g., greater than 0% by weight to 0.1% carbon, preferably 0.02% by weight to 0.08% by weight carbon); up to 0.5% by weight hafnium (e.g., greater than 0% by weight to 0.5% by weight hafnium); and/or up to 0.1% by weight zirconium (e.g., greater than 0% by weight to 0.1% by weight zirconium); with the balance being nickel. For example, the component may be in the combustion section 130 of the turbomachine 120 described above with respect to FIG. 4, such as in the outer combustor casing 258, the inner combustor casing 260, and the combustor 262 including the outer combustion chamber liner 264 and the inner combustion chamber liner 266.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component, which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets, laser jets, and binder jets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable “additively manufacturable” material that may be utilized in such additive manufacturing techniques. For example, the material may be plastic, metal, concrete, ceramic, polymer, epoxy, photopolymer resin, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel based superalloys or cobalt based superalloys (e.g., those available under the name Inconel® available from Special Metals Corporation). These materials are examples of materials suitable for use in the additive manufacturing processes described herein and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer that corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

Notably, in exemplary embodiments, several features of the components described herein were previously not possible due to manufacturing restraints. However, the present inventors have advantageously utilized current advances in additive manufacturing techniques to develop exemplary embodiments of such components generally in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

In this regard, utilizing additive manufacturing methods, even multi-part components may be formed as a single piece of continuous metal, and may thus include fewer sub-components and/or joints compared to prior designs. The integral formation of these multi-part components through additive manufacturing may advantageously improve the overall assembly process. For example, the integral formation reduces the number of separate parts that must be assembled, thus reducing associated time and overall assembly costs. Additionally, existing issues with, for example, leakage, joint quality between separate parts, and overall performance may advantageously be reduced.

Also, the additive manufacturing methods described above enable much more complex and intricate shapes and contours of the components described herein. For example, such components may include thin additively manufactured layers and unique fluid passageways with integral mounting features. In addition, the additive manufacturing process enables the manufacture of a single component having different materials such that different portions of the component may exhibit different performance characteristics. The successive, additive nature of the manufacturing process enables the construction of these novel features. As a result, the components described herein may exhibit improved functionality and reliability.

Ni-based superalloys are a useful family of alloys that can be designed to be used with substantial creep and oxidation resistances at high temperatures, often in excess of 70% of their absolute melting temperatures. Additive manufacturing is a suite of technologies that fabricate three-dimensional objects from digital models through an additive process, typically by depositing layer upon layer and joining them in place. Unlike traditional manufacturing processes involving subtraction (e.g., cutting and shearing) and forming (e.g., stamping, bending, and molding), additive manufacturing joins materials together to build products. Articles that are additively manufactured from superalloys are useful in high-temperature environments.

The present disclosure is generally related to metal articles additively manufactured with superalloys. Typically, metal articles undergo pressure heating at supersolvus temperatures (i.c., temperatures greater than the solvus temperature of precipitates in the metal article), which increases surface variation of the outer surface while recrystallizing the grain structure. The surface variation is then machined away in a polishing or abrading process. Additive manufacturing provides the ability to create geometries unlike those formed by subtractive methods, such as internal features that are difficult to machine and finish. As such, control of near-surface microstructures improves performance of parts where machining and finishing are difficult. In particular, for additively manufactured articles that have such complex geometries and internal features, the surface variation would remain after the supersolvus pressure heating process, reducing performance of the metal article.

By performing a subsolvus pressure heating process followed by a supersolvus heat treatment, surface variation of the metal article is reduced while the grain structure of the superalloy is recrystallized, improving performance of the metal article. In particular, the pressure heating process plastically deforms the metal article and closes pores that are not connected to an outer surface. The supersolvus heat treatment generates a preferred grain size. This sequence of processing is particularly useful for chromia-forming nickel-based superalloys, which lack an alumina scale that would inhibit surface variations from forming in the outer surface during a supersolvus heat treatment.

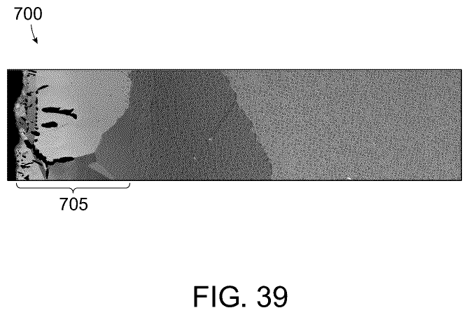

Referring now to the drawings, wherein identical numerals indicate the same elements throughout the figures, FIG. 39 is a photograph of a cross-section of an exemplary metal article 700 showing the grain structure of the metal article 700. As one example, the metal article 700 is an additively manufactured article formed by depositing layers of an alloy material. As described above, the additive manufacturing process that forms the metal article 700 may form complex geometries and internal surfaces that are difficult to smooth by mechanical methods, such as abrasion.

In this form, the metal article 700 includes a metal, such as a nickel-based superalloy, a cobalt-based superalloy, a steel such as stainless steel, a titanium alloy, or other metal commonly used in machine components. In certain embodiments, the article includes a superalloy, meaning a nickel-based superalloy (e.g., a superalloy with a nickel-containing base metal), iron-based superalloy or cobalt-based superalloy (e.g., a superalloy with a cobalt-containing base metal); in particular embodiments, the article includes a nickel-based superalloy. Illustrative nickel and cobalt-based superalloys are designated by the trade names INCONEL (e.g., INCONEL 718), NIMONIC, RENE (e.g., RENE 88, RENE 104 alloys), HAYNES, and UDIMET. For example, an alloy that can be used in making turbine disks, turbine shafts, and other useful components is a nickel-based superalloy available under the trade name INCONEL 718 that has a nominal composition, by weight, of 52.5% nickel, 19% chromium, 3% molybdenum, 3.5% manganese, 0.5% aluminum, 0.45% titanium, 5.1% combined tantalum and niobium, and 0.1% or less carbon, with the balance being iron. As another example, a nickel-based superalloy available under the trade name RENE 88DT has a nominal composition, by weight, of 13% cobalt, 16% chromium, 4% molybdenum, 4% tungsten, 2.1% aluminum, 3.7% titanium, 0.7% niobium, 0.03% carbon, and 0.015% boron.

In particular, the metal article 700 is formed from a metal alloy that lacks a protective metal-oxide layer on the outer surface of the metal article at a maximum temperature of a heat treatment process, such as a chromia-forming nickel-based superalloy (CNS). As an example, certain alloys that contain aluminum create alumina by oxidation of the aluminum when undergoing heat treatment, but even when the alumina is formed, the alumina does not form a contiguous outer layer. Example compositions of such alloys are shown in Table VIII below:

TABLE VIII
Compositions for metal article

| | Ni | Cr | Co | Al | W | Ti | Mo | Nb | Ta |
|---|---|---|---|---|---|---|---|---|---|
| Comp. 1 | Bal. | 10-20 | 10-25 | 0-6 | 0 | 0 | 0 | 0 | 0 |
| Comp. 2 | Bal. | 10-20 | 10-25 | 0-6 | 0-6 | 0-6 | 0-10 | 0-3 | 0-8 |
| Comp. 3 | Bal. | 12-17 | 11-20 | 1.5-4 | 2-6 | 2-4 | 2-6 | 1-3 | 1-6 |

In Table VIII, the numbers indicate composition by weight percent, and “Bal.” refers to the remaining balance of the weight being nickel. For example, Alloy 1 has a nominal composition, by weight, of 10-20% Cr, 10-25% Co, 0-6% Al, and the remainder Ni.

The metal article 700 has reduced surface variation 705 compared to articles formed with different heat treatments or with other alloys that are not alumina-forming. In this context, “surface variation” 705 is a region starting at an outer surface of the metal article 700 in which the grain structure of the metal varies. Specifically, the surface variation 705 of the metal article 700 of FIG. 39 is below 30 microns, which means that, beyond a depth of 30 microns from the outer surface, the grain structure of the metal article 700 is substantially consistent. The reduced surface variation 705 provides improved mechanical performance of the metal article 700, such as tensile strength, fatigue capability, creep capability, and the like. It will be appreciated that the metal article 700 of the present disclosure may have a surface variation below 125 microns, such as below 30 microns as shown in FIG. 39.

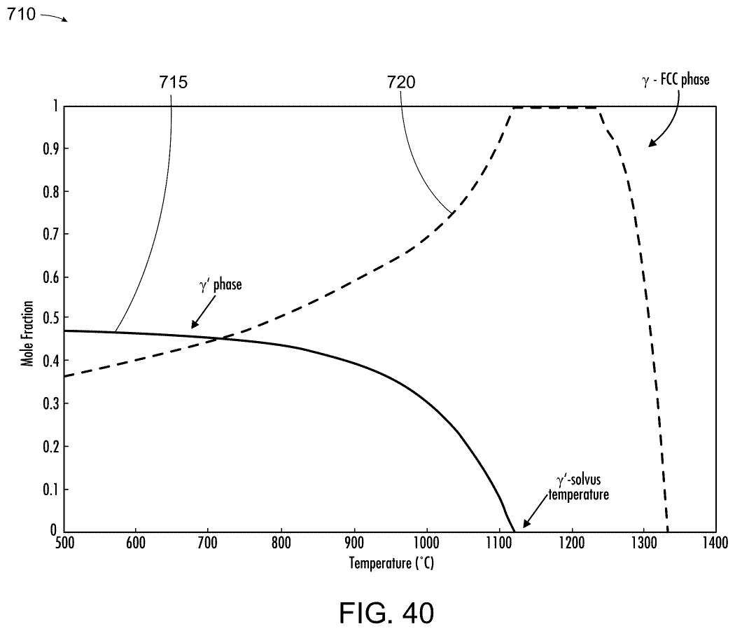

Now referring to FIG. 40, a phase diagram 710 of a chromia-forming nickel-based superalloy is shown. The phase diagram 710 shows a respective amount of different phases of the CNS at specific temperatures. The vertical axis shows the amount of the phase, measured in mole fraction. The horizontal axis shows temperature, in degrees Fahrenheit.

The phase diagram 710 in particular shows the amounts of two phases of the CNS: gamma prime phase (γ′) (shown by the line 715) and a gamma face-centered cubic (disordered γ-FCC) phase (shown by the line 720). Gamma prime is a precipitate that grows in a metal article 700 formed of the CNS. Gamma prime is an L1₂ (ordered FCC) crystal structure of composition Ni₃(Al, Ti). Gamma prime precipitates may also include several “gamma prime forming elements” including tantalum, niobium, and hafnium. FCC is an arrangement of the atoms of the CNS. As the temperature of the CNS increases, the mole fraction of γ′ decreases and the mole fraction of FCC increases. That is, the γ′ precipitates dissolve as the temperature increases. A temperature at which all of the γ′ dissolves (i.e., the mole fraction of γ′ is zero) is a “solvus” temperature, shown in FIG. 40 as the line 715 having a value of 0. Temperatures above the solvus temperature are “supersolvus,” and temperatures below the solvus temperature are “subsolvus.”

The metal article 700 can be heated to supersolvus and subsolvus temperatures during specific heat treatments. As an example, the metal article 700 can be heated in a heat treatment to a supersolvus temperature in a low-reactive environment (such a vacuum or gettered environment) to form a specific grain structure for the metal article 700. Specifically, heating the metal article 700 to the supersolvus temperature in the low-reactive environment causes grain boundaries and dislocations to reform into a recrystallized structure, improving microstructure integrity of the metal article without introducing additional surface variation 705. That is, in the low-reactive environment, fewer oxidation reactions occur, which allow for growth of γ′ precipitates from elements that would otherwise be consumed in the oxidation reactions.

Additionally, as described below, the metal article 700 can be heated to a subsolvus temperature to reduce the surface variation 705. The solvus temperature of the CNS alloy of FIG. 40 is typically from 1120° C.-1160° C. (2050° F.-2120° F.), and the metal article can be heated to a subsolvus temperature that is from 30-120 degrees Celsius below the solvus temperature, such as from 1000° C. to 1130° C. (1832° F. to 2065° F.), preferably in a range from 50-100 degrees Celsius below the solvus temperature. In particular, the subsolvus temperature can be determined to reduce diffusion of aluminum, titanium, or other γ′-forming elements to the outer surface of the metal article 700. The metal article 700 may undergo another supersolvus heat treatment, as described above, following the subsolvus heat treatment. In such a form where two supersolvus heat treatments are performed, the respective temperature for each of the supersolvus heat treatments may be a same temperature or a different temperature. The subsolvus heat treatment may inhibit the surface variation 705 from growing beyond a specified depth. The specified depth may be less than 125 microns, such as less than 30 microns.

After heating the metal article 700 at the supersolvus temperature, the metal article 700 may undergo a cooling process, such as quenching. That is, the metal article 700 is actively cooled to fix the recrystallized grain structure and/or the γ′ precipitate structure formed by the supersolvus heat treatment and subsequent cooling. Alternatively, the active cooling process may be omitted, and the metal article 700 may be cooled in ambient room temperatures that form the γ′ precipitate structure, such as 20-25° C. The metal article 700 may be actively cooled at a specific cooling rate, such as at least 45 degrees Celsius per minute (° C./min), at least 25° C./min, or at least 10° C./min.

Following the heat treatments, the metal article 700 may be aged at a subsolvus temperature to further precipitate and grow a preferred size distribution and amount of γ′. In particular, the distribution of γ′ provides specific material properties for the metal article 700, such as maintaining the strength and fatigue resistance of the metal article at high temperatures. That is, γ′ in specific amounts and sizes allows the metal article to gain the beneficial properties of superalloys. The subsolvus temperature may be the subsolvus temperature described above, e.g., from 1000° C. to 1130° C. (1832° F. to 2065° F.), or a lower temperature, such as 600° C.

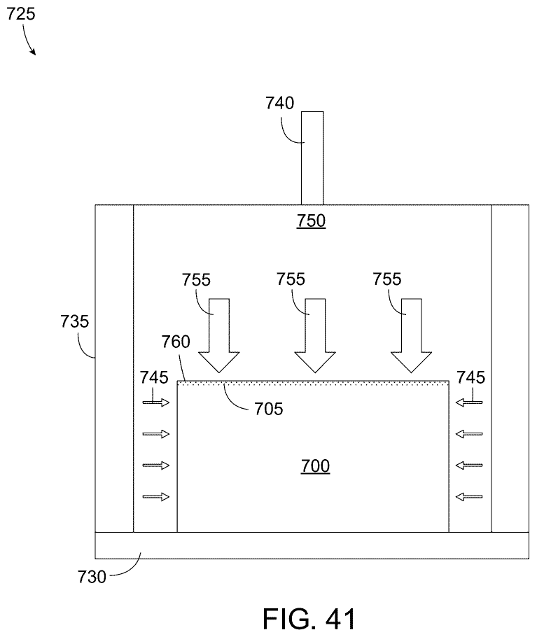

With reference to FIG. 41, a schematic view of an example metal article 700 undergoing a pressure heating process is shown. In this context, a “pressure heating” process is process by which pressure and heat are applied to the metal article 700 to cause a change to the material properties of the metal article. One such pressure heating process is a hot isostatic pressing process, and FIG. 41 illustrates an apparatus 725 for the hot isostatic pressing process.

The apparatus 725 includes a platform 730, a heater 735, and a pressurizer 740. The metal article 700 is placed on the platform 730 and heated by the heater 735, indicated by arrows 745. The apparatus 725 defines a sealed chamber 750 in which a gas is provided to a specific pressure, indicated by arrows 155, by the pressurizer 740. Specifically, the gas may be an inert gas, such as argon, such that the metal article 700 is in an inert environment in the sealed chamber750. Because the pressure and temperature remain relatively constant during the pressure heating process, the process is an isostatic method of hot pressing the metal article 700. As an example, the pressure in the sealed chamber may be in a range from 100 megapascals (MPa) to 200 MPa.

In particular, the apparatus 725 can pressure heat the metal article 700 at a subsolvus temperature of a γ′ to inhibit growth of surface variations 705 of an outer surface 760 of the metal article 700. That is, at the subsolvus temperature, the pressure and heat plastically deform the metal article 700, closing pores that are not connected with the outer surface 760. With the reduced surface variation 705, the metal article 700 can undergo additional heat treatment processes to attain a preferred grain and precipitate structure, as shown in FIG. 39. As described above, the metal article 700 may undergo a supersolvus heat treatment before the subsolvus pressure heating process, after the subsolvus pressure heating process, or both.

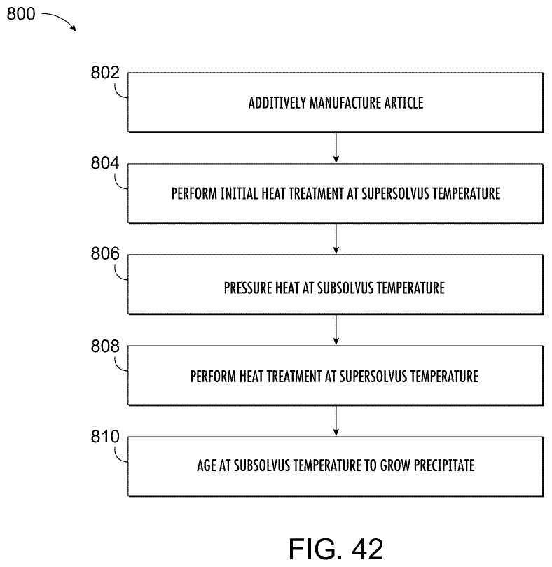

Referring now to FIG. 42, a flow diagram of a method 800 of processing a metal article in accordance with an exemplary aspect of the present disclosure is provided. The method 800 may be utilized to process the exemplary metal article 700 formed of a superalloy described above with reference to FIGS. 39-41.

As is depicted, the method 800 includes at (802) additively manufacturing the metal article. As described above, the metal article may be formed in an additive manufacturing process from a metal alloy, such as a chromia-forming nickel-based superalloy (CNS).

The method 800 includes at (804) performing an initial heat treatment at a supersolvus temperature to recrystallize the grain structure of the metal article. As described above, the metal article can be heated in a low-reactive environment at a temperature above a solvus temperature for a precipitate, such as γ′, as shown in FIG. 40. The heat treatment at the supersolvus temperature sets a recrystallized grain structure for the CNS.

The method 800 includes at (806) pressure heating the metal article at a subsolvus temperature. The pressure heating may occur as a hot isostatic pressing process in an apparatus as shown in FIG. 41. During the pressure heating, the metal article may plastically deform, closing pores while limiting or inhibiting surface microstructure variations. In particular, the pressure heating may be performed such that the surface variation of the metal article is less than 125 microns, such as less than 30 microns. The pressure heating may occur in an inert environment, such as an argon environment. It will be appreciated that the metal article may undergo pressure heating without an initial supersolvus heat treatment. That is, the method 800 may progress from step (802) directed to step (806), omitting step (804).

The method 800 includes at (808) performing a heat treatment at a supersolvus temperature in a low-reactive environment. Heating the metal article at the supersolvus temperature causes the grain boundaries and dislocations to reform into a recrystallized structure, improving microstructure integrity of the metal article. The supersolvus temperature of (808) may be a same temperature as the supersolvus temperature of (804). Alternatively, the supersolvus temperature of (808) may be a different temperature than the supersolvus temperature of (804). It will be appreciated that, when the step (804) is omitted, the sole supersolvus heat treatment of step (808) recrystallizes the grain structure of the metal article.

The method 800 includes at (810) aging the metal article at a subsolvus temperature to grow existing precipitates and nucleate and grow additional precipitates. More specifically, at the subsolvus temperature, precipitates such as γ′ may form in the metal article. Controlling the growth of the precipitates allows for specific material properties of the metal article.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: a turbomachine comprising a compressor section, a combustion section, and a turbine section arranged in serial flow order, the compressor section having a high pressure compressor defining a high pressure compressor exit area (A_{HPCExit}) in square inches; wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific determined as follows: Fn_{Total}×EGT/(A_{HPCExit}²×1000).

The gas turbine engine of the preceding clauses wherein the corrected specific thrust is from 42 to 90, such as from 45 to 80, such as from 50 to 80.

The gas turbine engine of the preceding clauses, wherein the EGT is greater than 1000 degrees Celsius and less than 1300 degrees Celsius.

The gas turbine engine of any preceding clause, wherein the EGT is greater than 1100 degree Celsius and less than 1250 degrees Celsius.

The gas turbine engine of any preceding clause, wherein the EGT is greater than 1150 degree Celsius and less than 1250 degrees Celsius.

The gas turbine engine of any preceding clause, wherein the EGT is greater than 1000 degree Celsius and less than 1300 degrees Celsius, and wherein the corrected specific thrust is greater than or equal to 45.

The gas turbine engine of any preceding clause, wherein the EGT is greater than 1000 degree Celsius and less than 1300 degrees Celsius, and wherein the corrected specific thrust is greater than or equal to 50.

The gas turbine engine of any preceding clause, wherein the turbine section comprises a high pressure turbine having a first stage of high pressure turbine rotor blades, and wherein the gas turbine engine further comprises: a cooled cooling air system in fluid communication with the first stage of high pressure turbine rotor blades.

The gas turbine engine of one or more of the preceding clause, wherein the cooled cooling air system is further in fluid communication with the high pressure compressor for receiving an airflow from the high pressure compressor, and wherein the cooled cooling air system further comprises a heat exchanger in thermal communication with the airflow for cooling the airflow.

The gas turbine engine of any preceding clause, wherein when the gas turbine engine is operated at a takeoff power level, the cooled cooling air system is configured to provide a temperature reduction of a cooling airflow equal to at least 15% of the EGT and up to 45% of the EGT.

The gas turbine engine of any preceding clause, wherein when the gas turbine engine is operated at a takeoff power level, the cooled cooling air system is configured to receive between 2.5% and 35% of an airflow through a working gas flowpath of the turbomachine at an inlet to a compressor of the compressor section.

The gas turbine engine of any preceding clause, further comprising a primary fan driven by the turbomachine.

The gas turbine engine of any preceding clause, further comprising an inlet duct downstream of the primary fan and upstream of the compressor section of the turbomachine; and a secondary fan located within the inlet duct.

The gas turbine engine of any preceding clause, wherein the gas turbine engine defines a bypass passage over the turbomachine, and wherein the gas turbine engine defines a third stream extending from a location downstream of the secondary fan to the bypass passage.

The gas turbine engine of any preceding clause, wherein the secondary fan is a single stage secondary fan.

A method of operating a gas turbine engine, comprising: operating the gas turbine engine at a takeoff power level, the gas turbine engine having a turbomachine with a high pressure compressor defining a high pressure compressor exit area (A_{HPCExit}) in square inches, the gas turbine engine defining a redline exhaust gas temperature (EGT) in degrees Celsius, a total sea level static thrust output (Fn_{Total}) in pounds, and a corrected specific thrust; wherein the corrected specific thrust is greater than or equal to 42 and less than or equal to 90, the corrected specific determined as follows: Fn_{Total}×EGT/(A_{HPCExit}²×1000).

The method of any preceding clause, wherein the EGT defined by the gas turbine engine is greater than 1000 degree Celsius and less than 1300 degrees Celsius.

The method of any preceding clause, wherein the EGT defined by the gas turbine engine is greater than 1100 degree Celsius and less than 1300 degrees Celsius.

The method of any preceding clause, wherein the EGT defined by the gas turbine engine is greater than 1000 degree Celsius and less than 1300 degrees Celsius, and wherein the corrected specific thrust defined by the gas turbine engine is greater than or equal to 45.

The method of any preceding clause, wherein operating the gas turbine engine at the takeoff power level further comprises reducing a temperature of a cooling airflow provided to a high pressure turbine of the gas turbine engine with a cooled cooling air system.

The method of any preceding clause, wherein reducing the temperature of the cooling airflow provided to the high pressure turbine of the gas turbine engine with the cooled cooling air system comprises providing a temperature reduction of the cooling airflow equal to at least 15% of the EGT and up to 45% of the EGT.

The gas turbine engine of any preceding clause, wherein the cooled cooling air systems includes a thermal bus cooled cooling air system (see, e.g., FIGS. 4 and 5).

The gas turbine engine of any preceding clause, wherein the cooled cooling air systems includes a dedicated heat exchanger cooled cooling air system (i.e., a cooled cooling air system including a heat exchanger dedicated to the cooled cooling air system).

The gas turbine engine of any preceding clause, wherein the cooled cooling air systems includes a bypass heat exchanger cooled cooling air system having a heat sink heat exchanger thermally coupled to an airflow through a bypass passage (see, e.g., FIG. 9).

The gas turbine engine of any preceding clause, wherein the cooled cooling air systems includes an air-to-air cooled cooling air system (a cooled cooling air system having a heat sink heat exchanger configured to transfer heat to an airflow; see, e.g., FIG. 9.

The gas turbine engine of any preceding clause, wherein the cooled cooling air systems includes an oil-to-air cooled cooling air system (a cooled cooling air system having a heat sink heat exchanger configured to transfer heat to an oil flow).

The gas turbine engine of any preceding clause, wherein the cooled cooling air systems includes a fuel-to-air cooled cooling air system (a cooled cooling air system having a heat sink heat exchanger configured to transfer heat to a fuel flow, such as a Jet A fuel flow, a liquid hydrogen or hydrogen gas fuel flow, etc.; see, e.g., FIG. 4). or a combination thereof. In one or more of the exemplary cooled cooling air systems described herein, the

The gas turbine engine of any preceding clause, wherein the cooled cooling air systems is configured to receive the cooling air from a downstream end of a high pressure compressor.

The gas turbine engine of any preceding clause, wherein the cooled cooling air systems is configured to receive the cooling air from an upstream end of the high pressure compressor.

The gas turbine engine of any preceding clause, wherein the cooled cooling air systems is configured to receive the cooling air from a downstream end of a low pressure compressor.

The gas turbine engine of any preceding clause, wherein the cooled cooling air systems is configured to receive the cooling air from an upstream end of the low pressure compressor.

The gas turbine engine of any preceding clause, wherein the cooled cooling air systems is configured to receive the cooling air from a location between compressors.

The gas turbine engine of any preceding clause, wherein the cooled cooling air systems is configured to receive the cooling air from a bypass passage.

A gamma-prime nickel-based superalloy comprises, by weight: 16.0 to 30.0% cobalt; 11.5 to 15.0% chromium; 4.0 to 6.0% tantalum; 2.0 to 4.0% aluminum; 1.5 to 6.0% titanium; up to 5.0% tungsten; 1.0 to 7.0% molybdenum; up to 3.5% niobium; up to 1.0% hafnium; 0.02 to 0.20% carbon; 0.01 to 0.05% boron; 0.02 to 0.10% zirconium; the balance essentially nickel and impurities, wherein the titanium: aluminum weight ratio is 0.5 to 2.0.

The gamma-prime nickel-based superalloy of any preceding clause, wherein the tantalum content is at least 4.4%.

The gamma-prime nickel-based superalloy of any preceding clause, wherein the tantalum content is 4.4 to 5.6%.

The gamma-prime nickel-based superalloy of any preceding clause, wherein the titanium: aluminum weight ratio is 0.54 to 1.83.

The gamma-prime nickel-based superalloy of any preceding clause, wherein the molybdenum: molybdenum+tungsten weight ratio is 0.24 to 0.76.

The gamma-prime nickel-based superalloy of any preceding clause, wherein the hafnium content is at least 0.1%.

The gamma-prime nickel-based superalloy of any preceding clause, wherein the gamma-prime nickel-based superalloy consists of, by weight, 17.1 to 20.9% cobalt, 11.5 to 14.3% chromium, 4.4 to 5.6% tantalum, 2.1 to 3.7% aluminum, 1.7 to 5.0% titanium, 1.0 to 5.0% tungsten, 1.3 to 4.9% molybdenum; 0.9 to 2.5% niobium, up to 0.6% hafnium, 0.02 to 0.10% carbon, 0.01 to 0.05% boron, 0.02 to 0.08% zirconium, the balance nickel and impurities, wherein the titanium: aluminum weight ratio is 0.54 to 1.83.

The gamma-prime nickel-based superalloy of any preceding clause, wherein the molybdenum: molybdenum+tungsten weight ratio is 0.24 to 0.76.

A component formed of the gamma-prime nickel-based superalloy of any preceding clause.

The component of any preceding clause, wherein the component is a powder metallurgy component chosen from the group consisting of turbine disks and compressor disks and blisks of gas turbine engines.

The gamma-prime nickel-based superalloy of any preceding clause, wherein the gamma-prime nickel-based superalloy consists of, by weight, 17.1 to 20.7% cobalt, 11.5 to 13.9% chromium, 4.5 to 5.6% tantalum, 2.1 to 3.5% aluminum, 2.8 to 4.0% titanium, 1.3 to 3.1% tungsten, 2.6 to 4.9% molybdenum; 0.9 to 2.0% niobium, 0.1 to 0.59% hafnium, 0.03 to 0.10% carbon, 0.01 to 0.05% boron, 0.02 to 0.08% zirconium, the balance nickel and impurities, wherein the titanium: aluminum weight ratio is 0.98 to 1.45.

The gamma-prime nickel-based superalloy of any preceding clause, wherein the molybdenum: molybdenum+tungsten weight ratio is 0.51 to 0.76.

The gamma-prime nickel-based superalloy of any preceding clause, wherein the gamma-prime nickel-based superalloy consists of, by weight, 18.8 to 20.7% cobalt, 12.6 to 13.9% chromium, 4.5 to 5.5% tantalum, 2.1 to 2.6% aluminum, 3.1 to 3.8% titanium, 1.3 to 1.6% tungsten, 4.0 to 4.9% molybdenum; 0.9 to 1.1% niobium, 0.13 to 0.38% hafnium, 0.03 to 0.10% carbon, 0.02 to 0.05% boron, 0.02 to 0.07% zirconium, the balance nickel and impurities, wherein the titanium: aluminum weight ratio is 1.18 to 1.45.

The gamma-prime nickel-based superalloy of any preceding clause, wherein the molybdenum: molybdenum+tungsten weight ratio is 0.71 to 0.76.

A component formed of the gamma-prime nickel-based superalloy of any preceding clause.

The component of any preceding clause, wherein the component is a powder metallurgy component chosen from the group consisting of turbine disks and compressor disks and blisks of gas turbine engines.

The gamma-prime nickel-based superalloy of any preceding clause, wherein the gamma-prime nickel-based superalloy consists of, by weight, 17.1 to 18.9% cobalt, 11.5 to 12.7% chromium, 4.6 to 5.6% tantalum, 2.9 to 3.5% aluminum, 2.8 to 3.4% titanium, 2.5 to 3.1% tungsten, 2.6 to 3.2% molybdenum; 1.3 to 1.6% niobium, 0.20 to 0.59% hafnium, 0.03 to 0.08% carbon, 0.01 to 0.04% boron, 0.03 to 0.08% zirconium, the balance nickel and impurities, wherein the titanium: aluminum weight ratio is 0.98 to 1.18.

The gamma-prime nickel-based superalloy of any preceding clause, wherein the molybdenum: molybdenum+tungsten weight ratio is 0.51 to 0.56.

A component formed of the gamma-prime nickel-based superalloy of any preceding clause.

The component according of any preceding clause, wherein the component is a powder metallurgy component chosen from the group consisting of turbine disks and compressor disks and blisks of gas turbine engines.

The gamma-prime nickel-based superalloy of any preceding clause, wherein the gamma-prime nickel-based superalloy has a gamma prime solvus temperature of not more than 1200° C.

A gamma-prime nickel-based superalloy comprises, by weight: 16.0 to 30.0% cobalt; 9.5 to 12.5% chromium; 4.0 to 6.0% tantalum; 2.0 to 4.0% aluminum; 2.0 to 3.4% titanium; 3.0 to 6.0% tungsten; 1.0 to 4.0% molybdenum; 1.5 to 3.5% niobium; up to 1.0% hafnium; 0.02 to 0.20% carbon; 0.01 to 0.05% boron; 0.02 to 0.10% zirconium; the balance essentially nickel and impurities; wherein the superalloy has a W+Nb-Cr value of at least −6, is free of observable amounts of sigma and eta phases, and exhibits a time to 0.2% creep at 1300° F. and 100 ksi of at least 1000 hours.

The gamma-prime nickel-based superalloy of any preceding clause, wherein the chromium content is 10.0 to 12.5 weight percent.

The gamma-prime nickel-based superalloy of any preceding clause, wherein the niobium content is 1.8 to 2.2 weight percent.

The gamma-prime nickel-based superalloy of any preceding clause, wherein the tungsten content is 3.0 to 5.0 weight percent.

The gamma-prime nickel-based superalloy of any preceding clause, wherein the chromium content is 10.0 to 12.5 weight percent, the niobium content is 1.8 to 2.2 weight percent, and the tungsten content is 3.0 to 5.0 weight percent.

The gamma-prime nickel-based superalloy of any preceding clause, wherein the titanium content is 2.5 to 2.9 weight percent.

The gamma-prime nickel-based superalloy of any preceding clause, wherein the molybdenum content is 2.5 to 3.0 weight percent.

The gamma-prime nickel-based superalloy of any preceding clause, wherein the gamma-prime nickel-based superalloy consists of, by weight: 16.0 to 30.0% cobalt; 9.5 to 12.5% chromium; 4.0 to 6.0% tantalum; 2.0 to 4.0% aluminum; 2.0 to 3.4% titanium; 3.0 to 6.0% tungsten; 1.0 to 4.0% molybdenum; 1.5 to 3.5% niobium; up to 1.0% hafnium; 0.02 to 0.20% carbon; 0.01 to 0.05% boron; 0.02 to 0.10% zirconium; the balance essentially nickel and impurities.

The gamma-prime nickel-based superalloy of any preceding clause, wherein the chromium content is 10.0 to 12.5 weight percent.

The gamma-prime nickel-based superalloy of any preceding clause, wherein the niobium content is 1.8 to 2.2 weight percent.

The gamma-prime nickel-based superalloy of any preceding clause, wherein the tungsten content is 3.0 to 5.0 weight percent.

The gamma-prime nickel-based superalloy of any preceding clause, wherein the chromium content is 10.0 to 12.5 weight percent, the niobium content is 1.8 to 2.2 weight percent, and the tungsten content is 3.0 to 5.0 weight percent.

The gamma-prime nickel-based superalloy of any preceding clause, wherein the titanium content is 2.5 to 2.9 weight percent and the molybdenum content is 2.5 to 3.0 weight percent.

A component formed of the gamma-prime nickel-based superalloy of any preceding clause.

The component of any preceding clause, wherein the component is a powder metallurgy component chosen from the group consisting of turbine disks and compressor disks and blisks of gas turbine engines.

A gamma-prime nickel-based superalloy consisting of, by weight: 17.0 to 20.5% cobalt; 10.0 to 12.5% chromium; 4.5 to 5.5% tantalum; 3.0 to 3.4% aluminum; 2.5 to 2.9% titanium; 3.0 to 5.0% tungsten; 2.5 to 3.0% molybdenum; 1.8 to 2.2% niobium; up to 0.6% hafnium; 0.048 to 0.068% carbon; 0.015 to 0.04% boron; 0.04 to 0.06% zirconium; the balance essentially nickel and impurities; wherein the superalloy has a W+Nb-Cr value of at least −6, is free of observable amounts of sigma and eta phases, and exhibits a time to 0.2% creep at 1300° F. and 100 ksi of at least 1000 hours.

The gamma-prime nickel-based superalloy of any preceding clause, wherein the chromium content is a maximum of 12.0 weight percent.

The gamma-prime nickel-based superalloy of any preceding clause, wherein the chromium content is 10.02 to 12.08 weight percent, the niobium content is 1.97 to 2.99 weight percent, and the tungsten content is 3.1 to 4.6 weight percent.

A component formed of the gamma-prime nickel-based superalloy of any preceding clause.

The component of any preceding clause, wherein the component is a powder metallurgy component chosen from the group consisting of turbine disks and compressor disks and blisks of gas turbine engines.

A nickel based alloy, comprising: 20 wt. % to 26 wt. % cobalt; 9 wt. % to 13 wt. % chromium; 2 wt. % to 6 wt. % iron; 3.5 wt. % to 6 wt. % aluminum; 9 wt. % to 13 wt. % tungsten; 6 wt. % to 9 wt. % tantalum; 0.06 wt. % to 0.20 wt. % boron; and the balance nickel.

The nickel based alloy of any preceding clause, wherein the nickel based alloy comprises gamma prime precipitates in a plurality of grain interiors and has a gamma prime solvus temperature of 1038° C. or greater.

The nickel based alloy of any preceding clause, wherein the nickel based alloy comprises 30% by volume or more gamma prime precipitates in the plurality of grain interiors.

The nickel based alloy of any preceding clause, wherein the nickel based alloy has a grain boundary phase fraction of 20% by volume or more.

The nickel based alloy of any preceding clause, wherein the nickel based alloy has a grain boundary phase lineal density of 310 precipitates per mm or greater.

The nickel based alloy of any preceding clause, wherein the nickel based alloy comprises precipitates of W-bearing phases along one or more grain boundaries.

The nickel based alloy of any preceding clause, wherein the W-bearing phase comprises Laves phase, mu phase, beta phase, sigma phase, borides, or carbides.

The nickel based alloy of any preceding clause, wherein the nickel based alloy comprises 0.065 wt. % to 0.155 wt. % boron.

The nickel based alloy of any preceding clause, wherein the nickel based alloy comprises 22% by weight to 24% by weight cobalt, 10% by weight to 12% by weight chromium, 3% by weight to 5% by weight iron, 4% by weight to 5.5% by weight aluminum, 10% by weight to 12% by weight tungsten, 7% by weight to 8% by weight tantalum, and 0.07% by weight to 0.15% by weight boron.

The nickel based alloy of any preceding clause, wherein the nickel based alloy further comprises greater than 0% by weight to 0.1% by weight carbon.

The nickel based alloy of any preceding clause, wherein the nickel based alloy further comprises 0.02% by weight to 0.08% by weight carbon.

The nickel based alloy of any preceding clause, wherein the nickel based alloy further comprises greater than 0% by weight to 0.5% by weight hafnium.

The nickel based alloy of any preceding clause, wherein the nickel based alloy further comprises greater than 0% by weight to 0.1% by weight zirconium.

A component for a gas turbine assembly comprising the nickel alloy of any preceding clause.

A nickel based alloy consisting of: 20 wt. % to 26 wt. % cobalt; 9 wt. % to 13 wt. % chromium; 2 wt. % to 6 wt. % iron; 3.5 wt. % to 6 wt. % aluminum; 9 wt. % to 13 wt. % tungsten; 6 wt. % to 9 wt. % tantalum; 0.06 wt. % to 0.20 wt. % boron; and the balance nickel.

The nickel based alloy of any preceding clause, wherein boron is included in an amount of 0.065 wt. % to 0.155 wt. % boron.

The nickel based alloy of any preceding clause, consisting of 22% by weight to 24% by weight cobalt, 10% by weight to 12% by weight chromium, 3% by weight to 5% by weight iron, 4% by weight to 5.5% by weight aluminum, 10% by weight to 12% by weight tungsten, 7% by weight to 8% by weight tantalum, and 0.07% by weight to 0.15% by weight boron.

A method for processing a metal article includes pressure heating the metal article at a first temperature that is below a solvus temperature of a precipitate to reduce growth of surface variation of an outer surface of the metal article and heating the metal article at a second temperature that is above the solvus temperature of the precipitate to form a recrystallized grain structure of the metal article.

The method of any of the preceding clauses, wherein the metal article is a metal alloy lacking a protective metal-oxide layer on the outer surface of the metal article at a maximum heat treatment temperature.

The method of any of the preceding clauses, wherein the metal alloy is a chromia-forming nickel-based superalloy.

The method of any of the preceding clauses, wherein the metal alloy includes 10-20% Cr, 10-25% Co, and 0-6% Al.

The method of any of the preceding clauses, wherein the metal alloy further includes 0-6% W, 0-6% Ti, 0-10% Mo, 0-3% Nb, and 0-8% Ta.

The method of any of the preceding clauses, wherein the metal alloy further includes 12-17% Cr, 11-20% Co, 1.5-4% Al, 2-6% W, 2-4% Ti, 2-6% Mo, 1-3% Nb, and 1-6% Ta.

The method of any of the preceding clauses, further including, prior to pressure heating the metal article, heating the metal article at a third temperature that is above the solvus temperature of the precipitate.

The method of any of the preceding clauses, wherein heating the metal article at the third temperature or heating the metal article at the second temperature further includes heating the metal article in a low-reactive environment.

The method of any of the preceding clauses, wherein the low-reactive environment is an inert environment including an inert gas.

The method of any of the preceding clauses, wherein the low-reactive environment is a vacuum.

The method of any of the preceding clauses, wherein the low-reactive environment is a gettered environment.

The method of any of the preceding clauses, wherein the low-reactive environment is environment with an oxygen concentration below 1%.

The method of any of the preceding clauses, wherein the metal article is an additively manufactured article.

The method of any of the preceding clauses, wherein pressure heating the metal article includes pressure heating the metal article in a hot isostatic pressing process.

The method any of the preceding clauses, wherein the hot isostatic pressing process includes applying a pressure to the metal article in a range from 100 to 200 megapascals.

The method of any of the preceding clauses, further including cooling the metal article at a rate of at least 10 degrees Celsius per minute after heating the metal article at the second temperature to control growth of the precipitate.

The method of any of the preceding clauses, wherein the rate of cooling is at least 25 degrees Celsius per minute.

The method of any of the preceding clauses, wherein the rate of cooling is at least 45 degrees Celsius per minute.

The method of any of the preceding clauses, wherein the precipitate is a gamma prime precipitate.

The method of any of the preceding clauses, wherein the gamma prime precipitate includes nickel and one of aluminum or titanium.

The method of any of the preceding clauses, wherein the gamma prime precipitate includes at least one of tantalum, niobium or hafnium.

The method of any of the preceding clauses, wherein the surface variation of the metal article following heating the metal article at the second temperature is less than 125 microns from the outer surface.

The method of any of the preceding clauses, wherein the surface variation is less than 30 microns from the outer surface.

The method of any of the preceding clauses, wherein the first temperature is a temperature from 30 to 120 degrees Celsius below the solvus temperature.

The method of any of the preceding clauses, wherein the first temperature is a temperature from 50 to 100 degrees Celsius below the solvus temperature

The method of any of the preceding clauses, further including aging the metal article at a third temperature that is below the solvus temperature of the precipitate.

The method of any of the preceding clauses, wherein the first temperature is a temperature in a range from 1000-1130 degrees Celsius.

The method of any of the preceding clauses, wherein pressure heating the metal article further includes closing one or more pores that are not connected with the outer surface of the metal article.

The method of any of the preceding clauses, wherein pressure heating the metal article further includes plastically deforming the metal article.

A metal article processed according to the method of any of the preceding clauses.

The metal article of any of the preceding clauses, wherein the metal article is a metal alloy that does not form a protective metal-oxide layer on the outer surface of the metal article at a maximum heat treatment temperature, wherein the metal alloy includes 10-20% Cr, 10-25% Co, and 0-6% Al.

The metal article of any of the preceding clauses, wherein the metal alloy further includes 0-6% W, 0-6% Ti, 0-10% Mo, 0-3% Nb, and 0-8% Ta.

A method for forming a metal article includes additively manufacturing the metal article from a chromia-forming nickel-based superalloy, heating the metal article at a first temperature that is above a solvus temperature of a gamma prime precipitate to form a recrystallized grain structure of the metal article, pressure heating the metal article at a second temperature that is below the solvus temperature of the gamma prime precipitate to reduce growth of surface variation of an outer surface of the metal article, heating the metal article at a third temperature that is above the solvus temperature of the gamma prime precipitate to re-form at least a portion of the recrystallized grain structure of the metal article, and aging the metal article at a fourth temperature that is below the solvus temperature of the gamma prime precipitate.

We claim:

1. A gas turbine engine comprising:
a turbomachine comprising a compressor section, a combustion section, and a turbine section arranged in serial flow order, the compressor section having a high pressure compressor defining a high pressure compressor exit area (A_{HPCExit}) in square inches; and
a disk component within the turbomachine, wherein the disk component comprises a gamma prime precipitation-strengthened nickel-based superalloy,
wherein the gas turbine engine defines a redline exhaust gas temperature (EGT) in degrees Celsius, a total sea level static thrust output (Fn_{Total}) in pounds, and a corrected specific thrust, wherein the corrected specific thrust is greater than or equal to 42 and less than or equal to 90, the corrected specific thrust determined as follows: Fn_{Total}×EGT/(A_{HPCExit}²×1000).

2. The gas turbine engine of claim 1, wherein the disk component is a turbine disk or a compressor disk.

3. The gas turbine engine of claim 1, wherein the disk component is a compressor disk.

4. The gas turbine engine of claim 1, wherein the disk component is an additively manufactured disk component.

5. The gas turbine engine of claim 1, wherein the gamma prime precipitation-strengthened nickel-based superalloy is formed by powder metallurgy to provide creep, tensile, and fatigue crack growth properties to meet the performance requirements of the disk component within the gas turbine engine.

6. The gas turbine engine of claim 1, wherein the gamma prime precipitation-strengthened nickel-based superalloy exhibits creep and hold time fatigue crack growth rate characteristics at temperatures of 1200° F. to meet the performance requirements of the disk component within the gas turbine engine.

7. The gas turbine engine of claim 6, wherein the EGT is greater than 1000° C. and less than 1300° C.

8. The gas turbine engine of claim 6, wherein the EGT is greater than 1100° C. and less than 1250° C.

9. The gas turbine engine of claim 6, wherein the EGT is greater than 1150 degree Celsius and less than 1250 degrees Celsius.

10. The gas turbine engine of claim 1, wherein the gamma prime precipitation-strengthened nickel-based superalloy contains chromium, tungsten, molybdenum, rhenium, cobalt, or mixtures thereof as principal elements that combine with nickel to form a gamma matrix.

11. The gas turbine engine of claim 1, wherein the gamma prime precipitation-strengthened nickel-based superalloy contains aluminum, titanium, tantalum, niobium, vanadium, or mixtures thereof as principal elements that combine with nickel to form a gamma prime precipitate strengthening phase.

12. The gas turbine engine of claim 8, wherein the gamma prime precipitate strengthening phase comprises Ni₃(Al,Ti).

13. The gas turbine engine of claim 1, wherein the disk component is a turbine disk or a compressor disk.

14. The gas turbine engine of claim 1, wherein the EGT is greater than 1000 degree Celsius and less than 1300 degrees Celsius, and wherein the corrected specific thrust is greater than or equal to 45.

15. The gas turbine engine of claim 1, wherein the EGT is greater than 1000 degree Celsius and less than 1300 degrees Celsius, and wherein the corrected specific thrust is greater than or equal to 50.

16. The gas turbine engine of claim 1, wherein the turbine section comprises a high pressure turbine having a first stage of high pressure turbine rotor blades, and wherein the gas turbine engine further comprises:
a cooled cooling air system in fluid communication with the first stage of high pressure turbine rotor blades.

17. The gas turbine engine of claim 1, further comprising a primary fan driven by the turbomachine.

18. The gas turbine engine of claim 17, further comprising an inlet duct downstream of the primary fan and upstream of the compressor section of the turbomachine; and
a secondary fan located within the inlet duct.

19. The gas turbine engine of claim 18, wherein the gas turbine engine defines a bypass passage over the turbomachine, and wherein the gas turbine engine defines a third stream extending from a location downstream of the secondary fan to the bypass passage.

20. The gas turbine engine of claim 19, wherein the secondary fan is a single stage secondary fan.
